(19) United States
(12) Patent Application Publication
(10) Pub. No.: US 2025/0209720 A1
(43) Pub. Date: Jun. 26, 2025

(54) TECHNIQUES FOR RENDERING CONTENT

(71) Applicant: Apple Inc., Cupertino, CA (US)

(72) Inventors: Xiao Jin YU, Sunnyvale, CA (US); David LUI, San Jose, CA (US); Matthew STOLL, San Jose, CA (US); Rikky Roy KOGANTI, Santa Clara, CA (US); Harlan B. HASKINS, Erie, CO (US); Andrew P. RICHARDSON, San Francisco, CA (US)

(21) Appl. No.: 19/081,856

(22) Filed: Mar. 17, 2025

Related U.S. Application Data
(63) Continuation of application No. 18/643,626, filed on Apr. 23, 2024, now abandoned.
(60) Provisional application No. 63/470,977, filed on Jun. 4, 2023.

(51) Int. Cl. G06T 15/00; G06T 15/04

(52) U.S. Cl. CPC G06T 15/005; G06T 15/04

(57) ABSTRACT

Some techniques are described herein for conditionally rendering assets. In some examples, such techniques include a computer system receiving a request to render an asset and, in response, measuring performance of the computer system to determine whether to initiate rendering of the asset. For example, the computer system can measure the performance by rendering another asset that is less complex and/or resource intensive as the asset so to estimate a result of rendering the asset. Other techniques are described herein for rendering assets in different manners. In some examples such techniques include a computer system receiving a request to render an asset and, in response, rendering the asset in different manners depending on one or more aspects of the file and one or more current performance measurements of the computer system. Other techniques are described herein for rendering a 3D model based on current performance measurements of a computer system.

### CROSS-REFERENCE TO RELATED APPLICATIONS

The present application is a continuation application of U.S. Non-Provisional patent application Ser. No. 18/643,626, entitled “TECHNIQUES FOR RENDERING CONTENT,” filed Apr. 23, 2024, which claims priority to U.S. Provisional Patent Application Ser. No. 63/470,977, entitled “TECHNIQUES FOR RENDERING CONTENT” filed Jun. 4, 2023, which are hereby incorporated by reference in their entireties for all purposes.

### BACKGROUND

Electronic devices are becoming increasingly complex. For example, some electronic devices are rendering three-dimensional (3D) models for display. Rendering such 3D models can take significant time and/or resources, particularly when the 3D models are more complex. Accordingly, there is a need to improve techniques for rendering content.

### SUMMARY

Current techniques for rendering content are generally ineffective and/or inefficient. For example, some techniques require an electronic device to render and/or cause another computer system to render a three-dimensional (3D) model without regard to how such rendering will affect the electronic device. This disclosure provides more effective and/or efficient techniques for rendering content using an example of a user device rendering a 3D model as a set of one or more 2D images. It should be recognized that other types of electronic devices and/or other types of content can be used with techniques described herein. For example, a user device can request that a server render a two-dimensional (2D) model using techniques described herein and that 2D model can be rendered in variable ways depending on current performance measurements of the server and/or a temporal requirement for when the user device requests to receive the rendered representation of the 2D model. In addition, techniques optionally complement or replace other techniques for rendering content.

Some techniques are described herein for conditionally rendering assets. In some examples, such techniques include a computer system receiving a request to render an asset and, in response, measuring performance of the computer system to determine whether to initiate rendering of the asset. For example, the computer system can measure the performance by rendering another asset that is less complex and/or resource intensive as the asset so to estimate a result of rendering the asset. In examples that a determination is made to not initiate rendering of the asset, the asset is not rendered and instead an indication that the asset has not been rendered is output. Other techniques are described herein for rendering assets in different manners. In some examples such techniques include a computer system receiving a request to render an asset and, in response, rendering the asset in different manners depending on one or more aspects of the file and one or more current performance measurements of the computer system. Similar to above, a current performance measurement of the one or more current performance measurements can be measured by rendering another asset. Other techniques are described herein for rendering a 3D model based on current performance measurements of a computer system. In some examples, such techniques include a computer system receiving a request to render a 3D model and, in response, rendering a 3D or 2D representation of the 3D model depending on one or more current performance measurements of the computer system. While discussed in this paragraph separately, it should be recognized that one or more techniques described herein can be combined in some examples.

In some examples, a method that is performed at a computer system is described. In some examples, the method comprises: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a non-transitory computer-readable storage medium storing one or more programs configured to be executed by one or more processors of a computer system is described. In some examples, the one or more programs includes instructions for: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a transitory computer-readable storage medium storing one or more programs configured to be executed by one or more processors of a computer system is described. In some examples, the one or more programs includes instructions for: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a computer system is described. In some examples, the computer system comprises one or more processors and memory storing one or more programs configured to be executed by the one or more processors. In some examples, the one or more programs includes instructions for: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a computer system is described. In some examples, the computer system comprises means for performing each of the following steps: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a computer program product is described. In some examples, the computer program product comprises one or more programs configured to be executed by one or more processors of a computer system. In some examples, the one or more programs include instructions for: receiving a request to render a first asset; in response to receiving the request to render the first asset, measuring performance of the computer system to identify a current performance measurement of the computer system; and after measuring performance of the computer system: in accordance with a determination that a first set of one or more criteria is satisfied with respect to the first item, wherein the first set of one or more criteria includes a criterion based on one or more characteristics of the first asset and the current performance measurement of the computer system, rendering the first asset; and in accordance with a determination that a second set of one or more criteria is satisfied, wherein the second set of one or more criteria is different from the first set of one or more criteria, forgoing initializing rendering of the first asset.

In some examples, a method that is performed at a computer system is described. In some examples, the method comprises: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a non-transitory computer-readable storage medium storing one or more programs configured to be executed by one or more processors of a computer system is described. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a transitory computer-readable storage medium storing one or more programs configured to be executed by one or more processors of a computer system is described. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a computer system is described. In some examples, the computer system comprises one or more processors and memory storing one or more programs configured to be executed by the one or more processors. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a computer system is described. In some examples, the computer system comprises means for performing each of the following steps: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof, and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a computer program product is described. In some examples, the computer program product comprises one or more programs configured to be executed by one or more processors of a computer system. In some examples, the one or more programs include instructions for: receiving a request to render a first asset; and in response to receiving the request to render the first asset: in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

In some examples, a method that is performed at a computer system is described. In some examples, the method comprises: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

In some examples, a non-transitory computer-readable storage medium storing one or more programs configured to be executed by one or more processors of a computer system is described. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

In some examples, a transitory computer-readable storage medium storing one or more programs configured to be executed by one or more processors of a computer system is described. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

In some examples, a computer system is described. In some examples, the computer system comprises one or more processors and memory storing one or more programs configured to be executed by the one or more processors. In some examples, the one or more programs includes instructions for: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

In some examples, a computer system is described. In some examples, the computer system comprises means for performing each of the following steps: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

In some examples, a computer program product is described. In some examples, the computer program product comprises one or more programs configured to be executed by one or more processors of a computer system. In some examples, the one or more programs include instructions for: receiving a request to render a first asset; and in response to receiving the request to render the first asset: in accordance with a determination that a first set of one or more criteria is satisfied, wherein the first set of one or more criteria includes a criterion based on one or more current performance measurements of the computer system, rendering a three-dimensional representation of the first asset; and in accordance with a determination that a second set of one or more criteria is satisfied, wherein the second set of one or more criteria includes a criterion based on the one or more current performance measurements of the computer system, rendering a two-dimensional representation of the first asset, wherein the second set of one or more criteria is different from the first set of one or more criteria.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example system architecture including various electronic devices that may implement the subject system in accordance with some examples.

FIG. 2 illustrates a block diagram of example features of an electronic device in accordance with some examples.

FIGS. 3A-3K illustrates exemplary user interfaces in accordance with some examples.

FIG. 4 is a flow diagram illustrating a method for conditionally rendering assets in accordance with some examples.

FIG. 5 is a flow diagram illustrating a method for rendering assets in different manners in accordance with some examples.

FIG. 6 is a flow diagram illustrating a method for rendering content in accordance with some examples.

FIG. 7 illustrates an electronic system with which some examples of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other examples. In some examples, structures and components are shown in block diagram form in order to avoid obscuring the concepts of the subject technology.

Methods and/or processes described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, a system or computer readable storage medium can repeat the steps of a method as many times as needed to ensure that all of the contingent steps have been performed.

Although the following description uses terms “first,” “second,” “third,” etc. to describe various elements, these elements should not be limited by the terms. In some examples, these terms are used to distinguish one element from another. For example, a first subsystem could be termed a second subsystem, and, similarly, a subsystem device could be termed a subsystem device, without departing from the scope of the various described examples. In some examples, the first subsystem and the second subsystem are two separate references to the same subsystem. In some examples, the first subsystem and the second subsystem are both subsystems, but they are not the same subsystem or the same type of subsystem.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

A physical environment refers to a physical world that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and, in response, adjust graphical content and an acoustic field presented to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head mountable system may have one or more speaker(s) and an integrated opaque display. Alternatively, a head mountable system may be configured to accept an external opaque display (e.g., a smartphone). The head mountable system may incorporate one or more imaging sensors to capture images or video of the physical environment, and/or one or more microphones to capture audio of the physical environment. Rather than an opaque display, a head mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some examples, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

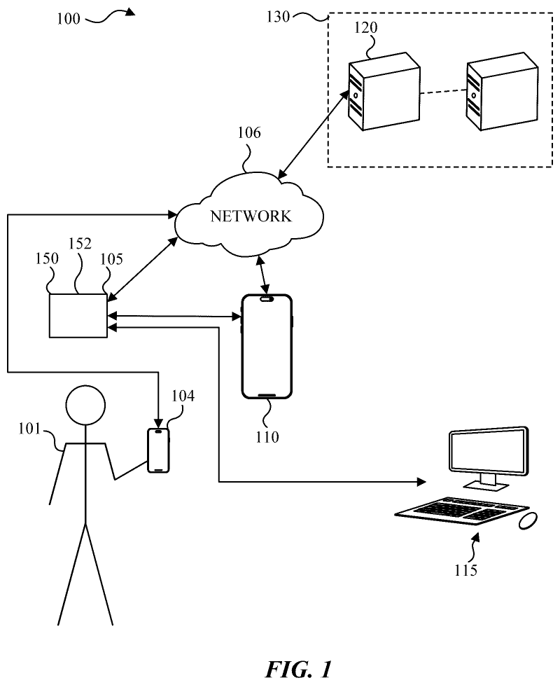

FIG. 1 illustrates an example system architecture 100 including various electronic devices that may implement the subject system in accordance with some examples. Not all of the depicted components may be used in all examples, however, and some examples may include additional or different components than those shown in the figure. Variations in the arrangement and type of the components may be made without departing from the spirit or scope of the claims as set forth herein. Additional components, different components, or fewer components may be provided.

The system architecture 100 includes an electronic device 105, a handheld electronic device 104, an electronic device 110, an electronic device 115, and a server 120. For explanatory purposes, the system architecture 100 is illustrated in FIG. 1 as including the electronic device 105, the handheld electronic device 104, the electronic device 110, the electronic device 115, and the server 120; however, the system architecture 100 may include any number of electronic devices, and any number of servers or a data center including multiple servers.

The electronic device 105 may be implemented, for example, as a tablet device, a smartphone, or as a head mountable portable system (e.g., worn by a user 101). The electronic device 105 includes a display system capable of presenting a visualization of an extended reality environment to the user. The electronic device 105 may be powered with a battery and/or another power supply. In an example, the display system of the electronic device 105 provides a stereoscopic presentation of the extended reality environment, enabling a three-dimensional visual display of a rendering of a particular scene, to the user. In some examples, instead of, or in addition to, utilizing the electronic device 105 to access an extended reality environment, the user may use a handheld electronic device 104, such as a tablet, watch, mobile device, and the like.

The electronic device 105 may include one or more cameras such as camera(s) 150 (e.g., visible light cameras, infrared cameras, etc.) For example, the electronic device 105 may include multiple cameras 150. For example, the multiple cameras 150 may include a left facing camera, a front facing camera, a right facing camera, a down facing camera, a left-down facing camera, a right-down facing camera, an up facing camera, one or more eye-facing cameras, and/or other cameras. Each of the cameras 150 may include one or more image sensors (e.g., charged coupled device (CCD) image sensors, complementary metal oxide semiconductor (CMOS) image sensors, or the like).

Further, the electronic device 105 may include various sensors 152 including, but not limited to, other cameras, other image sensors, touch sensors, microphones, inertial measurement units (IMU), heart rate sensors, temperature sensors, depth sensors (e.g., Lidar sensors, radar sensors, sonar sensors, time-of-flight sensors, etc.), GPS sensors, Wi-Fi sensors, near-field communications sensors, radio frequency sensors, etc. Moreover, the electronic device 105 may include hardware elements that can receive user input such as hardware buttons or switches. User inputs detected by such cameras, sensors, and/or hardware elements may correspond to, for example, various input modalities. For example, such input modalities may include, but are not limited to, facial tracking, eye tracking (e.g., gaze direction), hand tracking, gesture tracking, biometric readings (e.g., heart rate, pulse, pupil dilation, breath, temperature, electroencephalogram, olfactory), recognizing speech or audio (e.g., particular hotwords), and activating buttons or switches, etc. In some examples, facial tracking, gaze tracking, hand tracking, gesture tracking, object tracking, and/or physical environment mapping processes (e.g., system processes and/or application processes) may utilize images (e.g., image frames) captured by one or more image sensors of the cameras 150 and/or the sensors 152.

In some examples, the electronic device 105 may be communicatively coupled to a base device such as the electronic device 110 and/or the electronic device 115. Such a base device may, in general, include more computing resources and/or available power in comparison with the electronic device 105. In an example, the electronic device 105 may operate in various modes. For instance, the electronic device 105 can operate in a standalone mode independent of any base device. When the electronic device 105 operates in the standalone mode, the number of input modalities may be constrained by power and/or processing limitations of the electronic device 105 such as available battery power of the device. In response to power limitations, the electronic device 105 may deactivate certain sensors within the device itself to preserve battery power and/or to free processing resources.

The electronic device 105 may also operate in a wireless tethered mode (e.g., connected via a wireless connection with a base device), working in conjunction with a given base device. The electronic device 105 may also work in a connected mode where the electronic device 105 is physically connected to a base device (e.g., via a cable or some other physical connector) and may utilize power resources provided by the base device (e.g., where the base device is charging the electronic device 105 and/or providing power to the electronic device 105 while physically connected).

When the electronic device 105 operates in the wireless tethered mode or the connected mode, a least a portion of processing user inputs and/or rendering the extended reality environment may be offloaded to the base device thereby reducing processing burdens on the electronic device 105. For instance, in an example, the electronic device 105 works in conjunction with the electronic device 110 or the electronic device 115 to generate an extended reality environment including physical and/or virtual objects that enables different forms of interaction (e.g., visual, auditory, and/or physical or tactile interaction) between the user and the generated extended reality environment in a real-time manner. In an example, the electronic device 105 provides a rendering of a scene corresponding to the extended reality environment that can be perceived by the user and interacted with in a real-time manner, such as a host environment for a group session with another user. Additionally, as part of presenting the rendered scene, the electronic device 105 may provide sound, and/or haptic or tactile feedback to the user. The content of a given rendered scene may be dependent on available processing capability, network availability and capacity, available battery power, and current system workload. The electronic device 105 may be, and/or may include all or part of, the electronic system discussed below with respect to FIG. 10.

The network 106 may communicatively (directly or indirectly) couple, for example, the electronic device 105, the electronic device 110, and/or the electronic device 115 with each other device and/or the server 120. In some examples, the network 106 may be an interconnected network of devices that may include, or may be communicatively coupled to, the Internet.

The handheld electronic device 104 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the handheld electronic device 104 may not include a touchscreen but may support touchscreen-like gestures, such as in an extended reality environment. In some examples, the handheld electronic device 104 may include a touchpad. In FIG. 1, by way of example, the handheld electronic device 104 is depicted as a tablet device.

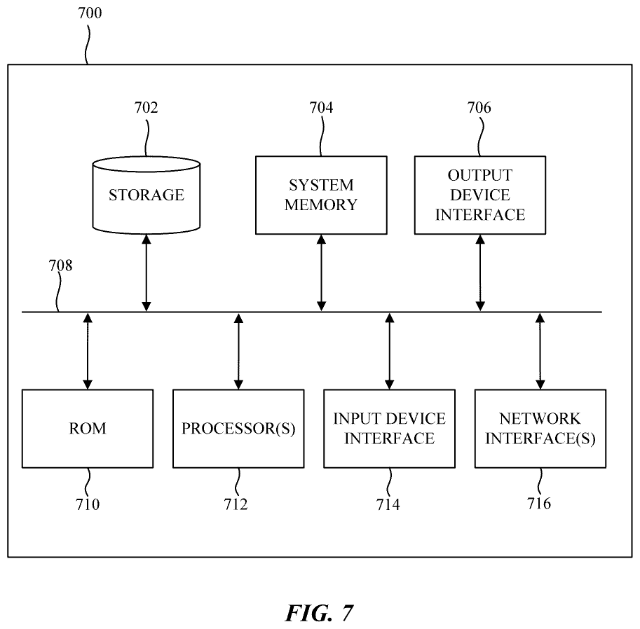

The electronic device 110 may be, for example, a smartphone, a portable computing device such as a laptop computer, a companion device (e.g., a digital camera, headphones), a tablet device, a wearable device such as a watch, a band, and the like, or any other appropriate device that includes, for example, one or more speakers, communications circuitry, processing circuitry, memory, a touchscreen, and/or a touchpad. In some examples, the electronic device 110 may not include a touchscreen but may support touchscreen-like gestures, such as in an extended reality environment. In some examples, the electronic device 110 may include a touchpad. In FIG. 1, by way of example, the electronic device 110 is depicted as a tablet device. In some examples, the electronic device 110, the handheld electronic device 104, and/or the electronic device 105 may be, and/or may include all or part of, the electronic system discussed below with respect to FIG. 7. In some examples, the electronic device 110 may be another device such as an Internet Protocol (IP) camera, a tablet, or a companion device such as an electronic stylus, etc.

The electronic device 115 may be, for example, desktop computer, a portable computing device such as a laptop computer, a smartphone, a companion device (e.g., a digital camera, headphones), a tablet device, a wearable device such as a watch, a band, and the like. In FIG. 1, by way of example, the electronic device 115 is depicted as a desktop computer having one or more cameras 150 (e.g., multiple cameras 150). The electronic device 115 may be, and/or may include all or part of, the electronic system discussed below with respect to FIG. 7.

The server 120 may form all or part of a network of computers or a group of servers 130, such as in a cloud computing or data center implementation. For example, the server 120 stores data and software, and includes specific hardware (e.g., processors, graphics processors and other specialized or custom processors) for rendering and generating content such as graphics, images, video, audio and multi-media files for extended reality environments. In an example, the server 120 may function as a cloud storage server that stores any of the aforementioned extended reality content generated by the above-discussed devices and/or the server 120.

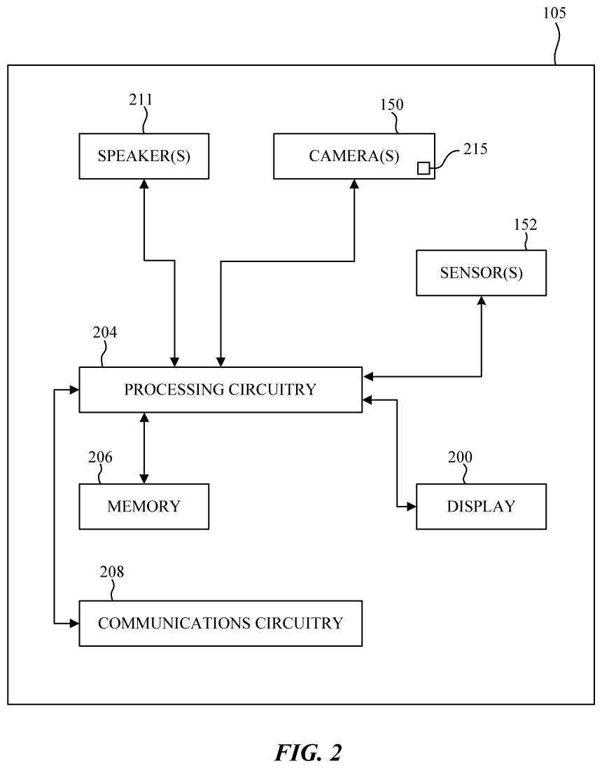

FIG. 2 illustrates a block diagram of various components that may be included in electronic device 105, in accordance with aspects of the disclosure. As shown in FIG. 2, electronic device 105 may include one or more cameras such as camera(s) 150 (e.g., multiple cameras 150, each including one or more image sensors 215) that capture images and/or video of the physical environment around the electronic device, one or more sensors 152 that obtain environment information (e.g., depth information) associated with the physical environment around the electronic device 105. Sensors 152 may include depth sensors (e.g., time-of-flight sensors, infrared sensors, radar, sonar, lidar, etc.), one or more microphones, and/or other types of sensors for sensing the physical environment. For example, one or more microphones included in the sensor(s) 152 may be operable to capture audio input from a user of the electronic device 105, such as a voice input corresponding to the user speaking into the microphones. In the example of FIG. 2, electronic device 105 also includes communications circuitry 208 for communication with electronic device 110, electronic device 115, servers 120, and/or other devices and/or systems in some examples. Communications circuitry 208 may include radio frequency (RF) communications circuitry for detecting radio frequency identification (RFID) tags, Bluetooth Low Energy (BLE) communications circuitry, other near-field communications (NFC) circuitry, WiFi communications circuitry, cellular communications circuitry, and/or other wired and/or wireless communications circuitry.

As shown, electronic device 105 includes processing circuitry 204 (e.g., one or more processors and/or integrated circuits) and memory 206. Memory 206 may store (e.g., temporarily or permanently) content generated by and/or otherwise obtained by electronic device 105. In some operational scenarios, memory 206 may temporarily store images of a physical environment captured by camera(s) 150, depth information corresponding to the images generated, for example, using a depth sensor of sensors 152, meshes and/or textures corresponding to the physical environment, virtual objects such as virtual objects generated by processing circuitry 204 to include virtual content, and/or virtual depth information for the virtual objects. Memory 206 may store (e.g., temporarily or permanently) intermediate images and/or information generated by processing circuitry 204 for combining the image(s) of the physical environment and the virtual objects and/or virtual image(s) to form, e.g., composite images for display by display 200, such as by compositing one or more virtual objects onto a pass-through video stream obtained from one or more of the cameras 150.

As shown, the electronic device 105 may include one or more speakers 211. The speakers may be operable to output audio content, including audio content stored and/or generated at the electronic device 105, and/or audio content received from a remote device or server via the communications circuitry 208.

Memory 206 may store instructions or code for execution by processing circuitry 204, such as, for example operating system code corresponding to an operating system installed on the electronic device 105, and application code corresponding to one or more applications installed on the electronic device 105. The operating system code and/or the application code, when executed, may correspond to one or more operating system level processes and/or application level processes, such as processes that support capture of images, obtaining and/or processing environmental condition information, and/or determination of inputs to the electronic device 105 and/or outputs (e.g., display content on display 200) from the electronic device 105.

Attention is now directed towards techniques for rendering content. Such techniques are described in three different contexts: (1) a smart phone receiving from another user a message with a 3D model and displaying different content, (2) a head-mounted display (HMD) displaying different content in response to a request to render a 3D model, and (3) a personal computer with a single-user, multi-task operating system displaying different content in response to a request to render a 3D model. It should be recognized that other contexts, including other types of devices, user interface flows, and content, can be used with techniques described herein. For example, a smart watch can display different representations of a 2D model using techniques described herein. In addition, techniques optionally complement or replace other techniques for rendering content.

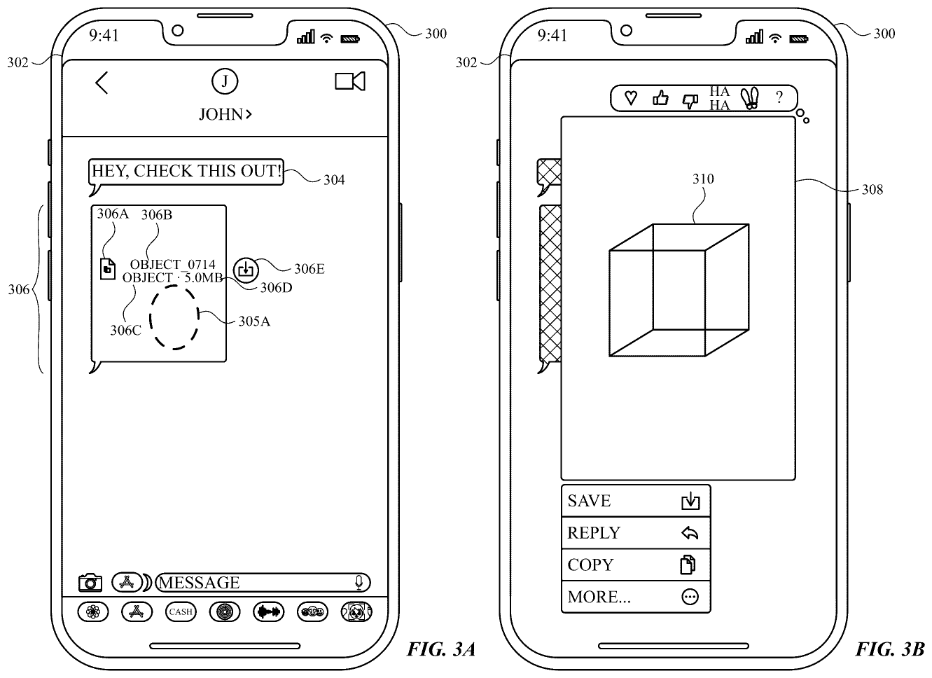

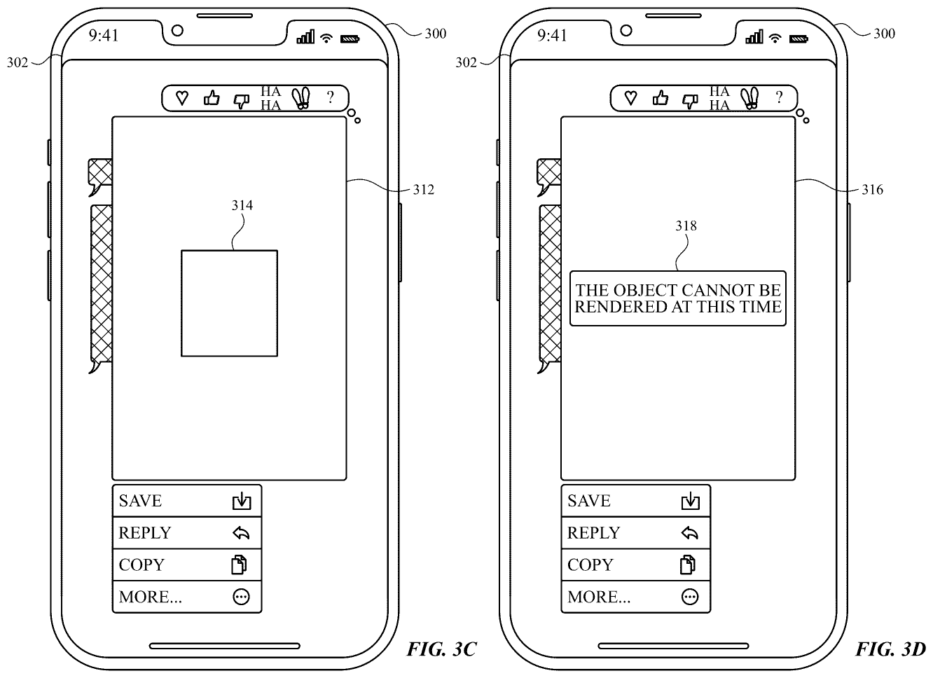

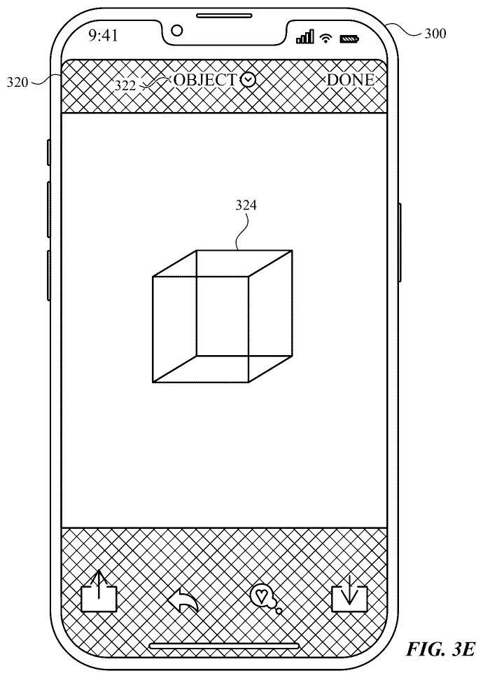

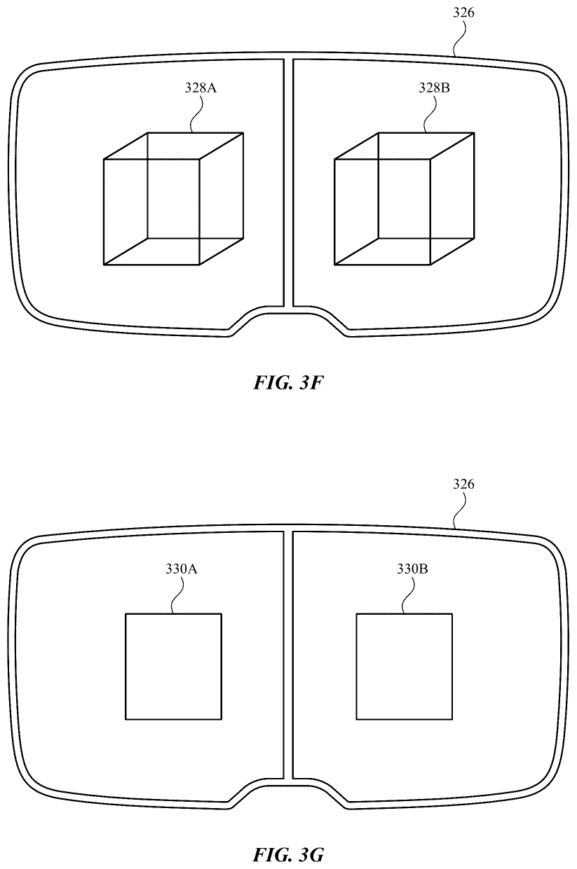

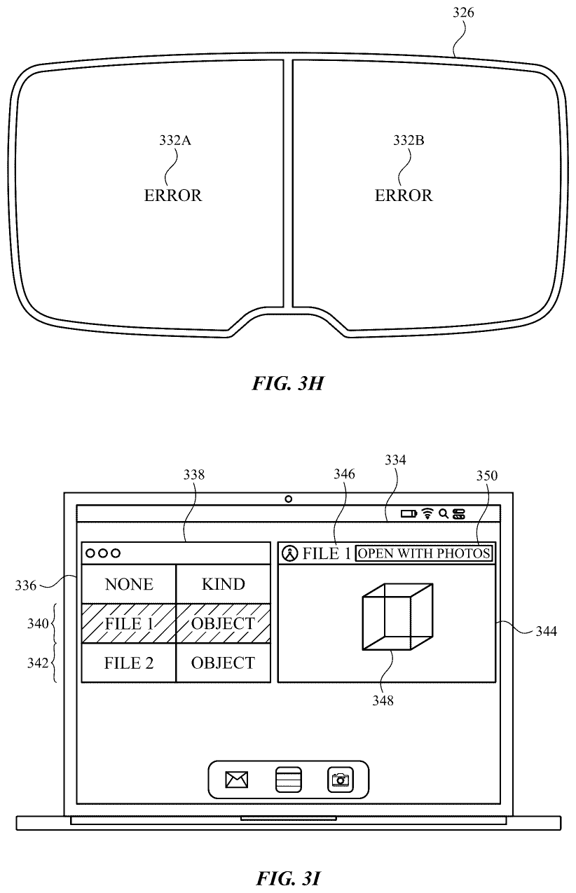

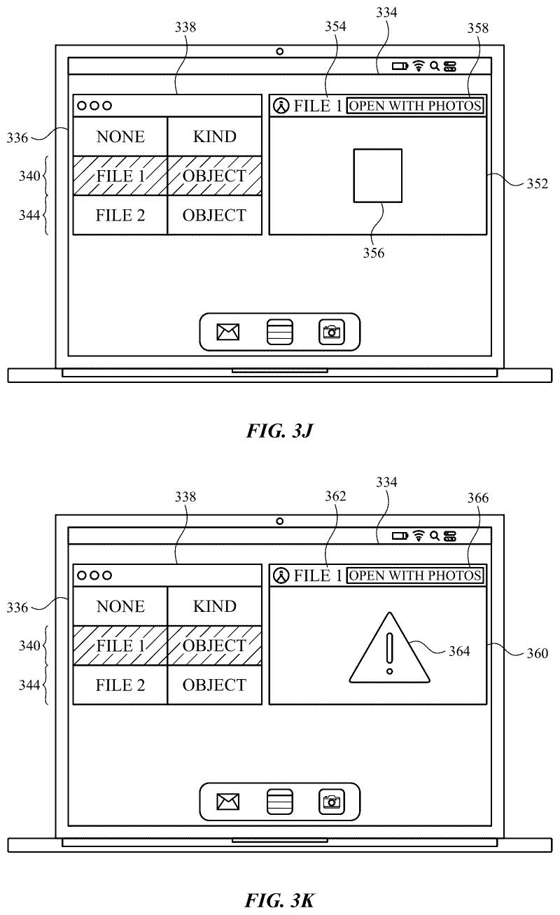

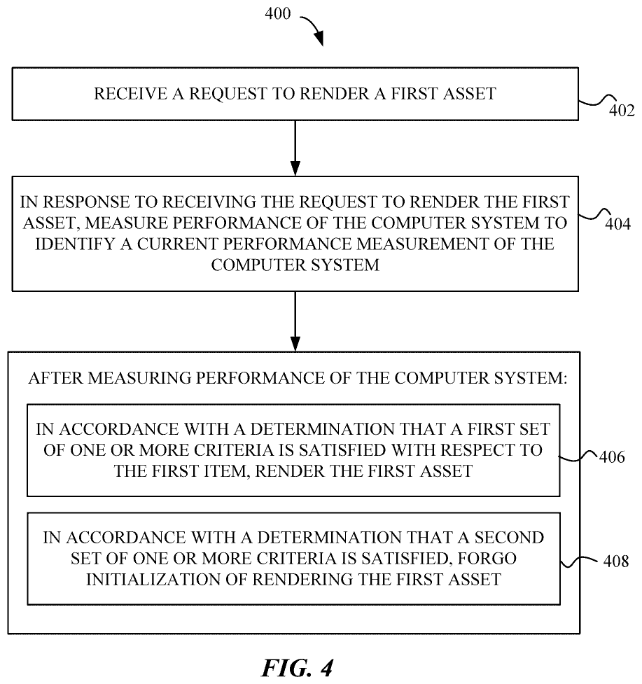

FIGS. 3A-3K illustrates exemplary user interfaces in accordance with some examples. The user interfaces in these figures are used to illustrate the processes described below, including the one or more processes described in relation to FIGS. 4-6.

As illustrated in FIGS. 3A-3K, exemplary user interfaces are displayed by three different computer systems: smart phone 300 in FIGS. 3A-3E, HMD 326 in FIGS. 3F-3H, and personal computer 334 in 3I-3K. In some examples, such computer systems each include one or more components described herein, including one or more components of electronic device 105, handheld electronic device 104, electronic device 110, electronic device 115, server 120, and/or electronic device 700. It should be recognized that such components are merely examples and more, less, and/or different components can be used with techniques described herein.

As described further below, FIGS. 3A-3K relate to techniques for rendering content. Some such techniques occur when loading content (e.g., a 3D model, a 2D model, and/or other type of content). For example, a computer system can identify one or more attributes of the content to determine a complexity of the content. In conjunction, the computer system can render other content with a defined set of one or more attributes. Such rendering of the other content can allow the computer system to interpolate results of rendering the other content to determine how rendering the content will perform. Based on the determination for how rendering the content will perform, the computer system can choose whether to initialize rendering of the content and, if so, in what manner to render the content (e.g., reducing complexities and/or operations required to render the content when increased performance is desired). In some examples, such techniques are performed via a system process (e.g., a daemon or other type of system process), an application (e.g., a user application, such as an application installed on a computer system), a program, a service, and/or a set of one or more instructions.

FIG. 3A illustrates smart phone 300 displaying messages user interface 302. In some examples, smart phone 300 is a smart phone that includes one or more applications, such as a messaging application corresponding to messages user interface 302. In such examples, the messaging application can allow a user to communicate with another computer system via messages that include different content. For example, FIG. 3A illustrates a messaging conversation between smart phone 300 and a computer system referred to as “John” with multiple messages received from John.

As illustrated in FIG. 3A, the messaging conversation in messaging user interface 302 includes text message 304 that says “Hey, check this out” and another message (e.g., content message 306) that includes content (e.g., a file with content displayable by smart phone 300 and/or an output device (e.g., another smart phone, a smart watch, a projector, a display screen, and/or an HMD)). In some examples, content message 306 includes display of information related to content message 306. As illustrated in FIG. 3A, content message 306 includes display of file icon 306A (e.g., an icon and/or thumbnail corresponding to the content of content message 306), title indication 306B (e.g., a title and/or file name corresponding to the content of content message 306), type indication 306C (e.g., a file type and/or content type corresponding to the content of content message 306), and size indication 306D (e.g., a size of a file and/or the content corresponding to content message 306). It should be recognized that more, less, and/or different information and/or a different format of information can be used for content message 306 in other examples.

As illustrated in FIG. 3A, smart phone 300 displays control 306E as part of content message 306. In some examples, selection of control 306E causes smart phone 300 to download, render, and/or display content corresponding to content message 306. For example, if the content corresponding to content message 306 is a 3D model, selection of control 306E can cause a full-fidelity, 3D representation of the 3D model to be downloaded, rendered, and/or displayed by smart phone 300. In some examples, selection of control 306E causes downloading and/or rendering of the content to occur in the background (e.g., as a background process instead of a foreground process) of smart phone 300 such that smart phone 300 can continue to be used by a user while the content is downloaded and/or rendered. In some examples, control 306E is not displayed by smart phone 300 and instead such downloading, rendering, and/or displaying occurs in response to smart phone 300 detecting input corresponding to content message 306, as discussed further below.

As illustrated in FIG. 3A, smart phone 300 detects input 305A at a location corresponding to content message 306. In some examples, different types of input can cause different operations to be performed. For example, a press-and-hold input directed to content message 306 can cause smart phone 300 to determine whether and/or how to render content corresponding to content message 306 and, in response to determining to render in a particular manner, render the content in the particular manner, as illustrated in FIGS. 3B-3C and discussed further below. In some examples, in which smart phone 300 determines not to render content corresponding to content message 306, smart phone 300 can output a notification that the content cannot be rendered at this time, as illustrated in FIG. 3D and discussed further below. For another example, a tap input directed to content message 306 can cause a full-fidelity representation of content corresponding to content message 306 to be displayed, as illustrated in FIG. 3E and discussed further below.

It should be recognized that such interactions with content message 306 as described above are examples of input causing a request to be received to render content. Other examples can include (1) a game that is moving from a first level of the game to a second level of the game and needing to render content for the second level, (2) a window of a desktop (e.g., as illustrated by FIGS. 3I-3K and discussed further below) with a file selected and an input to display content corresponding to the file, and (3) a first application requesting that another application begin execution and the other application needing content to be rendered to be displayed for the other application.

In some examples, in response to receiving the request to render content, smart phone 300 determines whether to initiate loading (e.g., into memory and/or into storage from another computer system) and/or rendering of the content. For example, smart phone 300 can download the content, and after downloading, determine whether to initiate rendering of the content. For another example, smart phone 300 can already have downloaded the content and instead determine whether to initiate loading of the content into memory and/or rendering of the content.

In some examples, as part of determining whether to initiate loading and/or rendering, smart phone 300 identifies one or more current performance measurements (e.g., current runtime performance measurements) associated with smart phone 300. Examples of a current performance measurement include number of operations executing and/or in queue to execute, amount of memory used and/or remaining, number of threads and/or processes executing, number of processors not executing and/or executing an operation, network bandwidth to obtain and/or retrieve the content, amount of current and/or anticipated load on smart phone 300, and/or other measurements related to performance of smart phone 300 that, optionally, affects, would affect, and/or be affected by loading and/or rending of the content.

In some examples, smart phone 300, based on whether the one or more current performance measurements exceed a threshold, can perform one or more other operations to measure performance of smart phone 300. In other examples, the one or more other operations are performed as part of identifying the one or more current performance measurements and are used to determine whether smart phone 300 initiates loading and/or rendering of the content.

An example of another operation includes loading and/or rendering other content and measuring time and/or effect on smart phone 300 while loading and/or rendering the other content. In some examples, such measurements are used so as to compare how loading and/or rending of the content would be performed. For example, the other content can be less complex (e.g., smaller, require less operations to be loaded and/or rendered, and/or require less resources to be loaded and/or rendered) and such can be loaded and/or rendered quicker and/or easier than the content and be indicative of how the content will be loaded and/or rendered. In some examples, the other content selected to be rendered can be based on the content such that the other content shares one or more attributes common to the content. In other examples, the other content is not selected but rather is predefined to be used to measure performance regardless of the content to be rendered. In some examples, a result of rendering the other content can be interpolated to predict an amount of time and/or resources to render the content. For example, if the other content is determined to be 10 times more complex than the content, the measurement for the other content would be multiplied by 10 to predict performance of loading and/or rendering the content. For another example, the content can include textures with 4K resolution and 100,000 vertices while the other content includes textures with 4K resolution and 10,000 vertices (e.g., the resolution of the textures is kept the same so that the number of vertices is the variable that is tested). In such an example, the time to render the other content can be multiplied by a predefined number for predicting time to complete content with 10 times more vertices.

In some examples, smart phone 300 identifies one or more attributes of the content so as to determine a complexity of the content. For example, smart phone 300 can request such information and/or analyze a file including the content for such information. Some examples of attributes include a number of vertices of a model, a texture size, a texture complexity, physics applied to the model, an animation performed by a representation of the model over time, a size of the model, and/or other information related to loading and/or rendering the model (e.g., indicative of time and/or resources needed for such operations). In some examples, instead of and/or in addition to the content defining one or more attributes of the content, a request to load and/or render the content includes one or more attributes for the content. For example, the request to load and/or render the content can include a size to render the content.

In some examples, if the amount of time and/or resources predicted for loading and/or rendering the content does not exceed a threshold (e.g., the predicted time and/or resources used for loading and/or rendering the content is determined to be below the threshold), smart phone 300 initiates loading and/or rendering of the content. In some examples, if the amount of time and/or resources predicted exceeds the threshold (e.g., too much time and/or too many resources), smart phone 300 forgoes initiating loading and/or rendering of the content. In other examples, smart phone 300 includes multiple thresholds such that when certain thresholds are exceeded then smart phone 300 iteratively reduces complexity of loading and/or rendering before forgoing initiating loading and/or rendering of the content. Such reductions can include loading and/or rendering less of the content, loading and/or rendering the content at a smaller size, and/or rendering the content in less resolution (e.g., a 2D representation rather than a 3D representation). Other operations that can be performed to reduce load on smart phone 300 while rendering and/or loading the content include changing audio from spatial to non-spatial, ceasing playback of audio, ceasing execution of an application and/or a process, reducing brightness of a display of smart phone 300, and/or slowing/stopping a network connection/communication.

FIG. 3B illustrates smart phone 300 displaying overlay 308 on top of messaging user interface 302. In some examples, overlay 308 is displayed in response to detecting input 305A in FIG. 3A. As illustrated in FIG. 3B, overlay 308 includes 3D representation 310, which is a cube that includes 8 vertices (e.g., each corner of the cube). In some examples, the cube is configured to be rotated and/or turned in response to detecting input, such as swipe gestures directed to the cube and/or movement of smart phone 300. Such animations can be defined by the content in content message 306 and be provided by 3D representation 310 when smart phone 300 determines that loading and/or rendering such is within an acceptable performance threshold for smart phone 300.

In some examples, overlay 308 is provided by a messaging application corresponding to messaging user interface 302. In such examples, the cube can correspond to (e.g., is configured to be opened by) a different application than the messaging application. For example, the cube can be presented in messaging user interface 302 when viewing the cube in response to particular types of input (e.g., a press-and-hold input on message content 306, as described above with respect to FIG. 3A) and presented in the different application (e.g., as illustrated in FIG. 3E and described further below) when viewing the cube in response to other types of input (e.g., a tap input on message content 306).

FIG. 3C illustrates smart phone 300 displaying overlay 312 on top of messaging user interface 302. In some examples, overlay 312 is displayed in response to detecting input 305A in FIG. 3A (e.g., instead of overlay 308 illustrated in FIG. 3B). As illustrated in FIG. 3C, overlay 312 includes 2D representation 314, which is a square that includes 4 vertices (e.g., each corner of the square). In some examples, the square is static and not able to be rotated and/or turned in response to detecting input. Such restrictions to 2D representation 314 can result from smart phone 300 determining that loading and/or rendering more than 2D representation 314 (e.g., 3D representation 310) is not within an acceptable performance threshold for smart phone 300.

In some examples, overlay 312 is provided by a messaging application corresponding to messaging user interface 302. In such examples, the square can correspond to (e.g., is configured to be opened by) a different application than the messaging application. For example, the square can be presented in messaging user interface 302 when viewing the square in response to particular types of input (e.g., a press-and-hold input on message content 306, as described above with respect to FIG. 3A) and presented (e.g., in a different format, such as a cube, or in the same format) in the different application when viewing the square in response to other types of input (e.g., a tap input on message content 306).

FIG. 3D illustrates smart phone 300 displaying overlay 316 on top of messaging user interface 302. In some examples, overlay 316 is displayed in response to detecting input 305A in FIG. 3A (e.g., instead of overlay 308 illustrated in FIG. 3B and/or overlay 312 illustrated in FIG. 3C). As illustrated in FIG. 3D, overlay 312 does not include a representation of content corresponding to content message 306 and instead includes error message 318, indicating that the object (e.g., content of content message 306) cannot be rendered at this time. In some examples, error message 318 is displayed as a result of smart phone 300 determining that loading and/or rendering a representation of content corresponding to content message 306 is not within an acceptable performance threshold for smart phone 300. It should be recognized that smart phone 300 can supplement error message 318 and/or provide an error message in other ways, including through audio and/or haptic feedback. In some examples, error message 318 indicates that content cannot be rendered by smart phone 300 at all, not just at this time.

In some examples, overlay 316 is provided by a messaging application corresponding to messaging user interface 302. In such examples, error message 318 can correspond to loading and/or rendering content with respect to the messaging application at a current time and not with respect to a different application than the messaging application and/or a different time. For example, content corresponding to content message 306 (e.g., 3D representation 310 and/or 2D representation 314) can be presented in the different application when viewing the content in response to other types of input (e.g., a tap input on message content 306) and/or input at a different time when smart phone 300 is operating under different circumstances.

FIG. 3E illustrates smart phone 300 displaying user interface 320. In some examples, user interface 320 is displayed in response to detecting input 305A in FIG. 3A (e.g., when input 305A is a different type of input (e.g., a tap input rather than a press-and-hold input) than used when causing overlay 308, 312, and/or 316 to be displayed). As illustrated in FIG. 3E, user interface 320 includes 3D representation 324, which is a cube that includes 8 vertices (e.g., each corner of the cube). In some examples, the cube is displayed while playing audio and/or includes different textures and/or is a different size than 3D representation 310. In such examples, the cube in user interface 320 can be configured to be rotated and/or turned in response to detecting input, such as swipe gestures directed to the cube and/or movement of smart phone 300. Such animations can be defined by the content in content message 306 and be provided by 3D representation 324 when smart phone 300 determines that loading and/or rendering such is within an acceptable performance threshold for smart phone 300.

In some examples, user interface 320 is not provided by messaging user interface 302 and instead is provided by a different application that is used to display content of content message 306. In such examples, the cube in user interface 320 can correspond to (e.g., is configured to be opened by) the different application.

FIGS. 3F-3H illustrate exemplary user interfaces of techniques described herein with respect to HMD 326. In some examples, HMD 326 is worn on a head of a user and provides content to each eye of the user. For example, as illustrated in FIG. 3F, HMD 326 can display left cube 328A on the left and right cube 328B on the right so that a user wearing HMD 326 sees a 3D cube. In some examples, HMD 326 displays content in response to input, such as input 305A described above with respect to FIG. 3A or input detected via HMD 326 without regard to smart phone 300. In some examples, such content can be rendered by smart phone 300 and/or HMD 326 to be displayed by HMD 326. In such examples, the same or similar determinations as described above can occur on smart phone 300 and/or HMD 326 before initializing rendering of content corresponding to left cube 328A and right cube 328B.

FIGS. 3I-3K illustrate exemplary user interfaces of techniques described herein with respect to personal computer 334. In some examples, personal computer 335 is a laptop or a desktop that is in communication with a mouse and/or a keyboard. In such examples, personal computer 335 can allow content from multiple applications at the same time, as discussed further below.

FIG. 3I illustrates personal computer 334 displaying desktop user interface 336. In some examples, desktop user interface 336 is managed and/or displayed by one or more system processes of personal computer 334. In such examples, desktop user interface 336 can include windows corresponding to different applications executing on personal computer 334. As illustrated in FIG. 3I, desktop user interface 336 includes browsing window 338. In some examples, browsing window 338 allows a user to navigate to different files and/or folders stored by personal computer 334. For example, FIG. 3I illustrates browsing window 338 including indications of multiple files (e.g., first file 340 and second file 342).

In some examples, while displaying an indication of a file, personal computer 334 detects an input (e.g., a tap input and/or directional input) corresponding to selection of a file. As illustrated in FIG. 3I, first file 340 is currently selected.

In some examples, while a file is selected, personal computer 334 detects an input (e.g., press of a space bar) corresponding to a request to render content of first file 340. In such examples, the request can be for a particular application to display content of first file 340, such as an application that is different from one set as a default application to view content of the type included in first file 340. In some examples, in response to detecting the input, personal computer 334 performs one or more determinations as described above to determine whether to initiate loading and/or rendering of the content.

In some examples, after and/or in response to rendering of the content, window 344 is displayed to include the rendered content (e.g., 3D representation 348). As illustrated in FIG. 3I, window 344 includes 3D representation 348, title 346 (e.g., a title of the rendered content, such as that included in browsing window 338), and control 350. In some examples, selection of control 350 causes a user interface of an application configured as default for the type of content of 3D representation 348 to be executed and/or displayed to present content corresponding to 3D representation 348. In some examples, the content presented in the user interface of the application is more complex and/or requires additional resources to load and/or render as compared to 3D representation 348.

FIG. 3J illustrates personal computer 334 displaying different content in desktop user interface 336 than illustrated in FIG. 3I. As illustrated in FIG. 3J, desktop user interface 336 includes window 344. In some examples, window 344 is displayed in response to detecting an input (e.g., press of a space bar) corresponding to a request to render content of first file 340 (e.g., as described above with respect to FIG. 3I). In some examples, in response to detecting the input, personal computer 334 performs one or more determinations as described above to determine whether to initiate loading and/or rendering of the content.

In some examples, after and/or in response to rendering the content, window 344 is displayed to include the rendered content (e.g., 2D representation 356). As illustrated in FIG. 3J, 2D representation 356 is different from 3D representation 348 illustrated in FIG. 3I. In some examples, such differences are a result of personal computer 344 determining that loading and/or rendering 3D representation 348 exceeds a performance threshold of personal computer 344 and that loading and/or rendering 2D representation 356 does not exceed the performance threshold.

FIG. 3K illustrates personal computer 334 displaying different content in desktop user interface 336 than illustrated in FIGS. 3I-3J. As illustrated in FIG. 3K, desktop user interface 336 includes window 360. In some examples, window 360 is displayed in response to detecting an input (e.g., press of a space bar) corresponding to a request to render content of first file 340 (e.g., as described above with respect to FIGS. 3I-3J). In some examples, in response to detecting the input, personal computer 334 performs one or more determinations as described above to determine whether to initiate loading and/or rendering of the content.

In some examples, in response to determining not to initiate loading and/or rendering of the content, window 360 is displayed and includes error message 364 without including a representation of first file 340 (e.g., 3D representation 348 and/or 2D representation 356). In some examples, error message 364 is displayed as a result of personal computer 344 determining that loading and/or rendering a representation of first file 340 exceeds a performance threshold of personal computer 344.

The illustrations above describe techniques herein with respect to a single model. It should be recognized that a request to render content can include multiple models and/or other types of content and that such determinations described above can be with respect to each piece of content (e.g., each model) serially or a combination of the content (e.g., the multiple models).

In some examples, after content is displayed (e.g., 3D representation 310, 2D representation 314, error message 318, left cube 328A, right cube 328B, left square 330A, right square 330B, left error 332A, right error 332B, 3D representation 348, 2D representation 356, and/or error message 364), a computer system (e.g., smart phone 300, HMD 326, and/or personal computer 334) determines whether performance of the computer system (and/or a computer system rendering the content) has changed. In such examples, when the performance has changed and a determination is made that a current performance exceeds and/or does not exceed a performance threshold, the computer system causes different content to be loaded, rendered, and/or displayed that satisfies the performance threshold. For example, while a 3D representation is displayed, the computer system can determine that rendering the 3D representation exceeds the performance threshold and, in response, cause rendering and display of a 2D representation and/or an error message.

It should be recognized that other operations can be performed to reduce effect of rendering the content, such as pausing animations, pausing physics simulation, and/or reducing size and/or complexity of a representation. In some examples, the computer system notifies a user of such reductions, such as by displaying a notification, outputting an audio indication, and/or outputting haptic feedback.

FIG. 4 is a flow diagram illustrating a method (e.g., method 400) for conditionally rendering assets in accordance with some examples. Some operations in method 400 are, optionally, combined, the orders of some operations are, optionally, changed, and some operations are, optionally, omitted.

In some examples, method 400 is performed at a computer system (e.g., a device, a personal device, a user device, and/or a head-mounted display (HMD)). In some examples, the computer system is a phone, a watch, a tablet, a fitness tracking device, a wearable device, a television, a multi-media device, an accessory, a speaker, and/or a personal computing device. In some examples, the computer system is in communication with input/output devices, such as one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi), fitness tracking devices (e.g., a smart watch and/or a smart ring), and/or near-field communication sensors). In some examples, the computer system is in communication with a display generation component (e.g., a projector, a display, a display screen, a touch-sensitive display, and/or a transparent display).

At 402, the computer system receives a request to render (e.g., display, create, generate and/or synthesize) a first asset (e.g., a static file, a model, a graphical representation, and/or an animation).

At 404, in response to receiving the request to render the first asset, the computer system measures (e.g., directly measures or causes measuring) (e.g., computes, ascertains, assesses, determines, and/or identifies) performance of the computer system to identify (e.g., determine and/or generate) a current performance measurement (e.g., an amount of time, available memory, available network bandwidth, and/or processor time) (e.g., an amount of latency) (e.g., a length of time and/or an amount of resources (e.g., time, memory, processor time, and/or number of operations) required to perform an operation) of the computer system (e.g., by performing an operation (e.g., rendering an asset different from the first asset) other than rendering the first asset).

At 406, after measuring performance of the computer system, in accordance with a determination that a first set of one or more criteria is satisfied with respect to the first item, wherein the first set of one or more criteria includes a criterion based on one or more characteristics (e.g., aspects, operations, requirements, and/or settings) of the first asset and the current performance measurement (e.g., a current system performance, a current state, and/or a current status) of the computer system, the computer system renders the first asset. In some examples, rendering the first asset includes providing a three-dimensional (3D) representation of the first asset. In some examples, rendering the first asset includes providing a two-dimensional (2D) representation of the first asset. In some examples, the computer system determines the one or more characteristics of the first asset via analysis of the first asset. In some examples, the computer system determines the one or more current performance measurements of the computer system via rendering another asset different from the first asset. In some examples, the computer system determines the one or more current performance measurements of the computer system via requesting such information, an API, and/or an IPC. In some examples, the first set of one or more criteria includes a criterion that is satisfied when a determination is made that the one or more characteristics of the first asset require a first amount of resources and the one or more current performance measurements indicate a second amount of resources (e.g., of the computer system) are available or used. In some examples, the second amount is the same as the first amount. In some examples, the second amount is different from (e.g., exceeds by at least a predefined threshold) the first amount.

At 408, after measuring performance of the computer system, in accordance with a determination that a second set of one or more criteria is satisfied, wherein the second set of one or more criteria is different from the first set of one or more criteria, the computer system forgoes initializing rendering of the first asset. In some examples, the second set of one or more criteria is satisfied when the first set of one or more criteria is not satisfied. In some examples, the second set of one or more criteria is satisfied when a criterion of the first set of one or more criteria is not satisfied. In some examples, the second set of one or more criteria includes a criterion that is satisfied when a determination is made that the one or more characteristics of the first asset require the first amount of resources and the one or more current performance measurements indicate a third amount of resources (e.g., of the computer system) are available or used. In some examples, the third amount of resources are less than the first amount of resources.

In some examples, the first asset includes a three-dimensional (3D) asset (e.g., a 3D model, such as a 3D model subject to one or more physics settings and/or an animation). In some examples, the first asset includes a two-dimensional (2D) asset. In some examples, the first asset includes text, an image, and/or a video.

In some examples, method 400 is performed by a system process (e.g., a daemon and/or a process of an operating system) of the computer system. In some examples, method 400 is performed by a user process of the computer system (e.g., a process of an application installed on the computer system) (e.g., and not performed by a system process (e.g., as described above) of the computer system). In some examples, method 400 is performed by a first application of the computer system. In some examples, the first asset corresponds to a second application of the computer system that is different from the first application. In some examples, the first asset corresponds to a second application of the computer system that is different from the first application. In some examples, in response to detecting an input corresponding to a request to open the first asset, the computer system opens the first asset via the second application (e.g., and not the first application).

In some examples, rendering the first asset includes displaying, via a first display generation component (e.g., a display screen, a touch-sensitive display, and/or a projector) in communication with the computer system, the first asset. In some examples, rendering the first asset includes synthesizing an image and/or a video. In some examples, displaying the first asset includes displaying a representation (e.g., a 3D representation and/or a 2D representation) of the first asset.

In some examples, after receiving the request to render the first asset, after measuring performance of the computer system, and in accordance with a determination that the second set of one or more criteria is satisfied, the computer system outputs, via one or more output devices (e.g., a speaker, a display generation component, and/or an haptic output generation component) in communication with the computer system, an indication (e.g., a warning message, an error message, a representation, a sound, and/or a haptic) that the first asset cannot be rendered (e.g., without displaying the first asset, a representation of the first asset, a representation rendered using the first asset, a 2D representation of the first asset, and/or a 3D representation of the first asset).

In some examples, the one or more characteristics include a number of vertices (e.g., a point in space that defines a shape of a model) desired (e.g., needed, wanted, required, and/or allowed) to be rendered for the first asset, a texture size (e.g., a length and/or widget of a portion of a model) (e.g., a size of an image) of a portion of a representation (e.g., a 3D or 2D representation) of the first asset, a physics setting applied to a representation of the first asset, an animation defined by the first asset, or a combination thereof. In some examples, the one or more characteristics include a number of rays needed to be traced to render the first asset. In some examples, the one or more characteristics include a number of objects needed to be rendered for the first asset. In some examples, the one or more characteristics define a complexity of the first asset. In some examples, the one or more characteristics are indications of an amount of time to render the first asset.

In some examples, performance of the computer system is measured by rendering a second asset different from the first asset. In some examples, the second asset requires less resources (e.g., memory and/or processor time) to render than the first asset. In some examples, the second asset is smaller than the first asset. In some examples, a representation resulting from rendering the second asset is smaller (e.g., less memory) than a representation resulting from rendering the first asset. In some examples, rendering the first asset requires a first amount of resources (e.g., of the computer system). In some examples, rendering the second asset requires a second amount of resources (e.g., of the computer system) different from the first amount of resources.

In some examples, the computer system receives (e.g., before, concurrently, or after rendering the first asset) a request to render a third asset different from the first asset. In some examples, after (e.g., in response to and/or at some time after) receiving the request to render the third asset (e.g., and in accordance with a determination that the first set of one or more criteria is not satisfied with respect to the third asset using an updated current performance measurement), the computer system forgoes initializing rendering of the third asset. In some examples, the updated current performance measurement is the same as the current performance measurement. In some examples, the current performance measurement is updated in response to receiving the request to render the third asset and, after updating, the current performance measurement is the same as before updating. In some examples, after not (and/or forgoing) rendering the first asset, the computer system receives a request to render a fourth asset different from the first asset; and, after (e.g., in response to and/or at some time after) receiving the request to render the fourth asset (e.g., and in accordance with a determination that the first set of one or more criteria is satisfied with respect to the fourth asset using the updated current performance measurement), the computer system renders the fourth asset.

In some examples, after rendering the first asset, the computer system receives a second request to render the first asset. In some examples, after (e.g., in response to and/or at some time after) receiving the second request to render the first asset (e.g., and in accordance with a determination that the first set of one or more criteria is not satisfied with respect to the first asset using an updated current performance measurement), the computer system forgoes initializing rendering of the third asset. In some examples, the updated current performance measurement is different from the current performance measurement. In some examples, the current performance measurement is updated in response to receiving the second request to render the third asset and, after updating, the current performance measurement is different from before updating. In some examples, after forgoing rendering the first asset, the computer system receives a third request to render the first asset. In some examples, after (e.g., in response to and/or at some time after) receiving the second request to render the first asset (e.g., and in accordance with a determination that the first set of one or more criteria is satisfied with respect to the first asset using the updated current performance measurement), the computer system renders the first asset.

In some examples, the criterion is based on a third request to render a respective asset. In some examples, the third request is different from (and/or distinct from and/or separate from) the request to render the first asset.

In some examples, the request to render the first asset includes a request to render a set of one or more assets different from (and/or does not include) the first asset. In some examples, the criterion is not based on a characteristic of an asset included in the set of one or more assets.

In some examples, the request to render the first asset includes a request to render one or more second assets different from the first asset. In some examples, the criterion is based on one or more characteristics of the one or more second assets.

In some examples, receiving the request to render the first asset includes detecting, via one or more input devices (e.g., a camera (e.g., a telephoto camera, a wide-angle camera, and/or an ultra-wide-angle camera), a microphone, a sensor (such as a heart rate sensor), a touch-sensitive surface, a mouse, a keyboard, a touch pad, and/or an input mechanism (e.g., a physical input mechanism, such as a rotatable input mechanism and/or a button)) in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) directed to a file (e.g., a container storing data and/or information) (e.g., a representation of the file) corresponding to the first asset.

In some examples, receiving the request to render the first asset includes detecting, via an application of the computer system, a request from a first portion of the application to render a second portion of the application. In some examples, the first portion corresponds to a first user interface and/or a portion of the first user interface. In some examples, the second portion corresponds to the portion of the first user interface, another portion different from the portion of the first user interface, and/or a second user interface different from the first user interface. In some examples, the first portion corresponds to a first portion (e.g., a level, an area of a virtual world, and/or a set of one or more objects) of an experience (e.g., a game, a central experience, and/or meeting point (e.g., socializing point and/or origin), and/or a currently viewable portion) of the application. In some examples, the second portion corresponds to a second portion (e.g., a second level different from the level, a second area of the virtual world different from the area, and/or a second set of one or more objects different from the set of one or more objects) of the experience of the application. In some examples, the second portion is different from the first portion.

In some examples, the first asset is rendered in a first manner (e.g., in a first resolution, a first format (e.g., as a 3D or 2D representation), and/or a first visual appearance) in response to receiving the request to render the first asset. In some examples, while the first asset is being displayed (e.g., after and/or as part of rendering the first asset), the computer system detects a change (e.g., increase and/or decrease) to the current performance measurement of the computer system. In some examples, in response to detecting the change to the current performance measurement, the computer system renders the first asset in a second manner (e.g., in a second resolution different from the first resolution, a second format different from the first format, and/or a second visual appearance different from the first visual appearance) different from (e.g., greater or lower than and/or requiring more or less resources to display as compared to) the first manner.

In some examples, rendering the first asset in the first manner includes providing (e.g., rendering, generating, and/or causing display of) a 3D representation of the first asset. In some examples, providing the first asset in the second manner includes providing a 2D representation of the first asset.

In some examples, rendering the first asset in the first manner includes providing an animation of the first asset or providing a representation of the first asset with a physics setting applied to the representation. In some examples, rendering the first asset in the second manner does not include providing an animation of the first asset and does not include providing a representation of the first asset with the physics setting applied to the representation.

In some examples, the first asset (e.g., after being rendered in the first manner or the second manner) is displayed while audio is playing (e.g., corresponding to the first asset). In some examples, in response to detecting the change to the current performance measurement, the computer system ceases playback of the audio (e.g., while displaying the first asset (e.g., after being rendered in the first manner or the second manner)).

In some examples, rendering the first asset in the first manner includes providing a first portion of the first asset with a first texture (e.g., a surface characteristic and/or appearance). In some examples, rendering the first asset in the second manner includes providing the first portion of the first asset with a second texture different from the first texture.

In some examples, rendering the first asset in the first manner includes providing the first asset in a first resolution. In some examples, rendering the first asset in the second manner includes providing the first asset in a second resolution different from (e.g., greater or lower than) the first resolution.

Note that details of the processes described above with respect to method 400 (e.g., FIG. 4) are also applicable in an analogous manner to other methods described herein. For example, method 500 optionally includes one or more of the characteristics of the various methods described above with reference to method 400. For example, the first asset of method 500 can be the first asset of method 500. For brevity, these details are not repeated below.

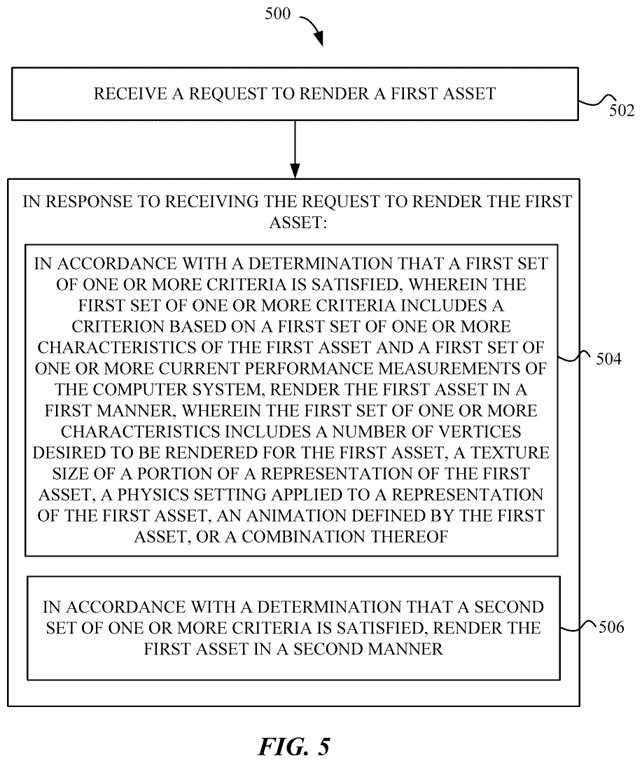

FIG. 5 is a flow diagram illustrating a method (e.g., method 500) for rendering assets in different manners in accordance with some examples. Some operations in method 500 are, optionally, combined, the orders of some operations are, optionally, changed, and some operations are, optionally, omitted. In some examples, method 500 is performed at a computer system (e.g., as described above with respect to method 400).

At 502, the computer system receives a request to render (e.g., as described above with respect to method 400) a first asset (e.g., as described above with respect to method 400).

At 504, in response to receiving the request to render the first asset, in accordance with a determination that a first set of one or more criteria is satisfied, wherein the first set of one or more criteria includes a criterion based on a first set of one or more characteristics of the first asset (e.g., as described above with respect to the one or more characteristics of the first asset for method 400) and a first set of one or more current performance measurements (e.g., as described above with respect to the one or more current performance measurements of the computer system for method 400) of the computer system, the computer system renders the first asset in a first manner (e.g., in a first resolution, a first format (e.g., as a 3D or 2D representation), and/or a first visual appearance), wherein the first set of one or more characteristics includes a number of vertices (e.g., a point in space that defines a shape of a model) desired (e.g., needed, wanted, required, and/or allowed) to be rendered for the first asset, a texture size (e.g., a length and/or widget of a portion of a model) (e.g., a size of an image) of a portion of a representation (e.g., a 3D or 2D representation) of the first asset, a physics setting (e.g., a setting that applies a force (e.g., gravity) and/or other modification to a representation of the first asset when rendered) applied to (e.g., during rendering) a representation of the first asset, an animation defined by the first asset, or a combination thereof. In some examples, the first set of one or more criteria includes a criterion that is satisfied when a first threshold is satisfied. In some examples, the criterion of the first set of one or more criteria is satisfied when the first set of one or more characteristics of the first asset require a first amount of resources and the second set of one or more current performance measurements indicate a second amount of resources (e.g., of the computer system) are available or used. In some examples, the second amount is the same as the first amount. In some examples, the second amount is different from (e.g., exceeds by at least a predefined threshold) the first amount.

At 506, in response to receiving the request to render the first asset, in accordance with a determination that a second set of one or more criteria is satisfied, wherein the second set of one or more criteria includes a criterion based on a second set of one or more characteristics of the first asset (e.g., as described above with respect to the one or more characteristics of the first asset for method 400) and a second set of one or more current performance measurements of the computer system (e.g., as described above with respect to the one or more current performance measurements of the computer system for method 400), the computer system renders the first asset in a second manner (e.g., in a second resolution different from the first resolution, a second format different from the first format, and/or a second visual appearance different from the first visual appearance) different from (e.g., greater or lower than and/or requiring more or less resources to display as compared to) the first manner (e.g., without rendering the first asset in the first manner), wherein the second set of one or more criteria is different from the first set of one or more criteria. In some examples, the first asset is rendered in the first manner without rendering the first asset in the second manner. In some examples, the second set of one or more characteristics is the first set of one or more characteristics. In some examples, the second set of one or more characteristics is different from the first set of one or more characteristics. In some examples, the second set of one or more current performance measurements is the first set of one or more current performance measurements. In some examples, the second set of one or more current performance measurements is different from the first set of one or more current performance measurements. In some examples, the second set of one or more criteria includes a criterion that is satisfied when a second threshold different from the first threshold is satisfied. In some examples, the criterion of the second set of one or more criteria is satisfied when the second set of one or more characteristics of the first asset require a third amount (e.g., the same or different from the first amount) of resources and the second set of one or more current performance measurements indicate a fourth amount (e.g., the same or different from the second amount, such as less than the second amount) of resources (e.g., of the computer system) are available or used. In some examples, the fourth amount is the same as the third amount. In some examples, the fourth amount is different from (e.g., exceeds by at least a predefined threshold) the third amount. In some examples, the second set of one or more characteristics includes a number of vertices (e.g., a point in space that defines a shape of a model) desired (e.g., needed, wanted, required, and/or allowed) to be rendered for the first asset, a texture size (e.g., a length and/or widget of a portion of a model) (e.g., a size of an image) of a portion of a representation (e.g., a 3D or 2D representation) of the first asset, a physics setting applied to a representation of the first asset, an animation defined by the first asset, or a combination thereof. In some examples, the second set of one or more criteria is satisfied when the first set of one or more criteria is not satisfied.

In some examples, rendering the first asset in the first manner includes providing a 3D representation of the first asset. In some examples, rendering the first asset in the second manner includes providing a 2D representation of the first asset.

In some examples, rendering the first asset in the first manner includes providing an animation of the first asset or rendering a representation of the first asset with a physics setting applied to the representation. In some examples, rendering the first asset in the second manner does not include rendering an animation of the first asset and does not include rendering a representation of the first asset with the physics setting applied to the representation.

In some examples, the first asset (e.g., after being rendered in the first manner or the second manner) is displayed while audio is playing (e.g., corresponding to the first asset). In some examples, in response to detecting a change to a current performance measurement (e.g., of the first set of one or more current performance measurements and/or the second set of one or more current performance measurements), the computer system ceases playback of the audio (e.g., while displaying the first asset (e.g., after being rendered in the first manner or the second manner)).

In some examples, rendering the first asset in the first manner includes providing a first portion of the first asset with a first texture (e.g., a surface characteristic and/or appearance). In some examples, rendering the first asset in the second manner includes providing the first portion of the first asset with a second texture different from the first texture.

In some examples, rendering the first asset in the first manner includes providing the first asset in a first resolution. In some examples, rendering the first asset in the second manner includes providing the first asset in a second resolution different from (e.g., greater or lower than) the first resolution.

In some examples, rendering the first asset (e.g., in the first manner or the second manner) includes displaying, via a first display generation component (e.g., a display screen, a touch-sensitive display, and/or a projector) in communication with the computer system, the first asset. In some examples, rendering the first asset includes synthesizing an image and/or a video in the first manner and/or the second manner. In some examples, displaying the first asset includes displaying a representation (e.g., a 3D representation and/or a 2D representation) of the first asset.

In some examples, a first performance measurement of the first set of one or more current performance measurements is measured (e.g., computed, ascertained, received, assessed, determined, and/or identified) before receiving the request to render the first asset.

In some examples, a second performance measurement of the first set of one or more current performance measurements is measured (e.g., computed, ascertained, received, assessed, determined, and/or identified) in response to receiving the request to render the first asset.

In some examples, a third performance measurement of the first set of one or more current performance measurements is determined by rendering another asset different from the first asset. In some examples, the third performance measurement is determined by computing an amount of resources (e.g., time, memory, network bandwidth, number of operations, and/or processor time) required for rendering the first asset (e.g., in the first manner and/or the second manner) using an amount of resources required to render the other asset. In some examples, the third performance measurement of the one or more current performance measurements is determined by comparing the amount of resources required for rendering the first asset and an amount (e.g., a target threshold) of resources available and/or used for a predefined amount of time (e.g., currently and/or predicted in the future). In some examples, the first asset is rendered in the first manner when the amount of resources required for rendering the first asset in the first manner is below the target threshold. In some examples, the first asset is rendered in the second manner when the amount of resources required for rendering the first asset in the second manner is below the target threshold.

In some examples, the computer system receives (e.g., before, concurrently, or after receiving the request to render the first asset and before, concurrently, or after rendering the first asset in the first manner) a request to render a second asset different from the first asset. In some examples, in response to receiving the request to render the second asset (e.g., and in accordance with a determination that the second set of one or more criteria is satisfied), the computer system renders the second asset in the second manner. In some examples, after receiving the request to render the first asset and after rendering the first asset in the second manner, the computer system receives a request to render a third asset different from the first asset. In some examples, in response to receiving the request to render the third asset (e.g., and in accordance with a determination that the first set of one or more criteria is satisfied), the computer system renders the third asset in the first manner.

In some examples, after receiving the request to render the first asset and after rendering the first asset in the first manner, the computer system receives a second request to render the first asset. In some examples, in response to receiving the second request to render the first asset (e.g., and in accordance with a determination that the second set of one or more criteria is satisfied), the computer system renders the first asset in the second manner. In some examples, after receiving the request to render the first asset and after rendering the first asset in the second manner, the computer system receives a third request to render the first asset. In some examples, in response to receiving the third request to render the first asset (e.g., and in accordance with a determination that the first set of one or more criteria is satisfied), the computer system renders the first asset in the first manner.

In some examples, receiving the request to render the first asset includes detecting, via one or more input devices (e.g., a camera (e.g., a telephoto camera, a wide-angle camera, and/or an ultra-wide-angle camera), a microphone, a sensor (such as a heart rate sensor), a touch-sensitive surface, a mouse, a keyboard, a touch pad, and/or an input mechanism (e.g., a physical input mechanism, such as a rotatable input mechanism and/or a button)) in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) directed to a file (e.g., a container storing data and/or information) (e.g., a representation of the file) corresponding to the first asset.

In some examples, receiving the request to render the first asset includes detecting, via an application of the computer system, a request from a first portion of the application to render a second portion of the application. In some examples, the first portion corresponds to a first user interface and/or a portion of the first user interface. In some examples, the second portion corresponds to the portion of the first user interface, another portion different from the portion of the first user interface, and/or a second user interface different from the first user interface. In some examples, the first portion corresponds to a first portion (e.g., a level, an area of a virtual world, and/or a set of one or more objects) of an experience (e.g., a game, a central experience, and/or meeting point (e.g., socializing point and/or origin), and/or a currently viewable portion) of the application. In some examples, the second portion corresponds to a second portion (e.g., a second level different from the level, a second area of the virtual world different from the area, and/or a second set of one or more objects different from the set of one or more objects) of the experience of the application. In some examples, the second portion is different from the first portion.

In some examples, while the first asset is being displayed (e.g., after and/or as part of rendering the first asset), the computer system detects a change to one or more current performance measurements (e.g., the first set of one or more current performance measurements and/or the second set of one or more current performance measurements) of the computer system. In some examples, in response to detecting the change to the one or more current performance measurements, the computer system renders the first asset in a different manner than the first asset that was displayed when detecting the change (e.g., when the first asset that is being displayed is rendered in the first manner, rendering the first asset in the second manner) (e.g., when the first asset that is being displayed is rendered in the second manner, the computer system renders the first asset in the first manner).

In some examples, in response to receiving the request to render the first asset and in accordance with a determination that a third set of one or more criteria is satisfied, wherein the third set of one or more criteria includes a criterion that is satisfied when the request to render the first asset does not include a size to render the first asset, the computer system renders the first asset at a first size (e.g., a default size). In some examples, the third set of one or more criteria includes the first set of one or more criteria or the second set of one or more criteria. In some examples, the third set of one or more criteria is different from the first set of one and/or more criteria or the second set of one or more criteria. In some examples, the first asset includes a predefined and/or predetermined size for the first asset (e.g., a size included in the first asset and/or a size defined and/or determined before receiving the request to render the first asset). In some examples, the predefined size is the first size. In some examples, the first asset is rendered at the first size in accordance with a determination that a set of one or more characteristics of the first asset as a set of one or more current performance measurements of the computer system satisfied a threshold for the first size (e.g., as described above). In some examples, in response to receiving the request to render the first asset and in accordance with a determination that a fourth set of one or more criteria is satisfied, wherein the fourth set of one or more criteria includes a criterion that is satisfied when the request to render the first asset includes a second size to render the first asset, the computer system renders the first asset at the second size, wherein the fourth set of one or more criteria is different from the third set of one or more criteria, and wherein the second size is different from the first size. In some examples, the fourth set of one or more criteria includes the first set of one or more criteria or the second set of one or more criteria. In some examples, the fourth set of one or more criteria is different from the first set of one and/or more criteria or the second set of one or more criteria. In some examples, the request to render the first asset including the second size means that the request to render the first asset includes a request to resize the first asset to the second size (e.g., instead of a default size for the first asset (e.g., the first size)). In some examples, the first asset is rendered at the second size in accordance with a determination that a set of one or more characteristics of the first asset as a set of one or more current performance measurements of the computer system satisfied a threshold for the first size (e.g., as described above). In some examples, the first asset is rendered at the second size not because of a current performance measurement but because the request to render the first asset includes the second size. In some examples, the first asset is not rendered (e.g., rendering is not initialized) when the asset cannot be rendered at the second size (e.g., the requested size). In some examples, the second size is a starting point for rendering the first asset and the second size can be reduced when a current performance metric requires (e.g., as described above). In some examples, the second size is a starting point for rendering the first asset and the second size cannot be reduced when a current performance metric requires (e.g., as described above) and instead the first asset is rendered in the second manner (e.g., as described above) when the current performance metric requires (e.g., in the second manner at the second size or in the second manner at a third size smaller than then second size).

Note that details of the processes described above with respect to method 500 (e.g., FIG. 5) are also applicable in an analogous manner to other methods described herein. For example, method 400 optionally includes one or more of the characteristics of the various methods described above with reference to method 500. For example, method 500 can include operations of method 400 that include forgoing initializing rendering of the first asset. For brevity, these details are not repeated below.

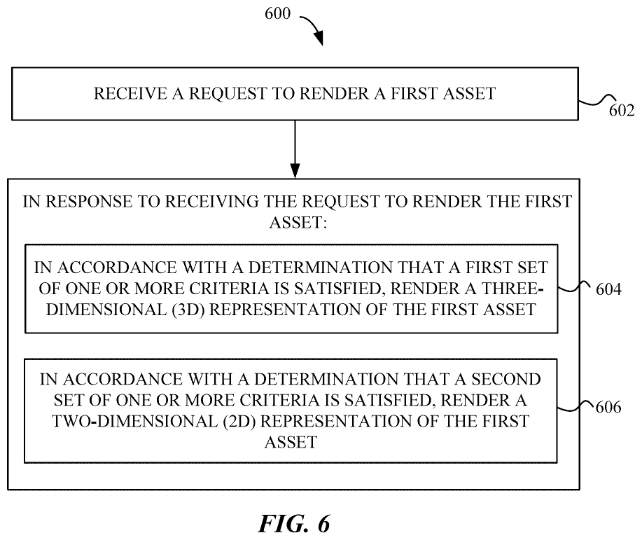

FIG. 6 is a flow diagram illustrating a method (e.g., method 600) for rendering content in accordance with some examples. Some operations in method 600 are, optionally, combined, the orders of some operations are, optionally, changed, and some operations are, optionally, omitted. In some examples, method 600 is performed at a computer system (e.g., as described above with respect to method 400).

At 602, the computer system receives a request to render (e.g., as described above with respect to method 400) a first asset (e.g., as described above with respect to method 400).

At 604, in response to receiving the request to render the first asset, in accordance with a determination that a first set of one or more criteria is satisfied, wherein the first set of one or more criteria includes a criterion based on one or more current performance measurements (e.g., as described above with respect to method 400) of the computer system, the computer system renders a three-dimensional (3D) representation of the first asset (e.g., without rendering a two-dimensional representation of the first asset). In some examples, the criterion of the first set of one or more criteria is satisfied when the one or more current performance measurements indicate an amount of available resources (e.g., of the computer system, such as battery, memory, an input and/or output device, and/or network bandwidth) exceed a threshold.

At 606, in response to receiving the request to render the first asset, in accordance with a determination that a second set of one or more criteria is satisfied, wherein the second set of one or more criteria includes a criterion based on the one or more current performance measurements of the computer system, the computer system renders a two-dimensional (2D) representation of the first asset (e.g., without rendering a 3D representation of the first asset), wherein the second set of one or more criteria is different from the first set of one or more criteria. In some examples, the second set of one or more criteria includes a criterion that is satisfied when a second threshold different from the first threshold is satisfied.

In some examples, the one or more current performance measurements include a current amount of power remaining in a power source (e.g., battery) in communication with the computer system.

In some examples, the one or more current performance measurements include a current amount of memory (e.g., random access memory, cache, temporary memory, long-term memory, and/or storage) remaining for the computer system. In some examples, the current amount of memory remaining for the computer system includes an amount of memory remaining in a storage device in communication with the computer system.

In some examples, the one or more current performance measurements include a current amount of network bandwidth (e.g., via one or more different network channels and/or via a network interface of the computer system) remaining for the computer system. In some examples, the one or more current performance measurements include a current amount of network latency.

In some examples, the one or more current performance measurements include whether an input device, an output device, or a combination thereof (e.g., a display generation component (e.g., a projector, a display, a display screen, a touch-sensitive display, and/or a transparent display), one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi)), fitness tracking devices (e.g., a smart watch and/or a smart ring), and/or near-field communication sensors) is currently in communication with the computer system (e.g., if a first type of input device is currently in communication with the computer system, rendering the 3D representation of the first asset) (e.g., if the first type of input device is not currently in communication with the computer system, rendering the 2D representation of the first asset) (e.g., if a second type of input device different from the first type of input device is currently in communication with the computer system, rendering the 2D representation of the first asset).

In some examples, the one or more current performance measurements include whether an input device, an output device, or a combination thereof (e.g., a display generation component (e.g., a projector, a display, a display screen, a touch-sensitive display, and/or a transparent display), one or more cameras (e.g., a telephoto camera, a wide-angle camera, and/or an ultra-wide-angle camera), speakers, microphones, sensors (e.g., heart rate sensor, monitors, antennas (e.g., using Bluetooth and/or Wi-Fi)), fitness tracking devices (e.g., a smart watch and/or a smart ring), and/or near-field communication sensors) is currently operating (e.g., inputting and/or outputting data) (e.g., if a first type of input device is currently operating, rendering the 3D representation of the first asset) (e.g., if the first type of input device is not currently operating, rendering the 2D representation of the first asset) (e.g., if a second type of input device different from the first type of input device is currently operating, rendering the 2D representation of the first asset).

In some examples, rendering a respective representation (e.g., the 3D and/or the 2D representation) of the first asset includes displaying, via a first display generation component (e.g., a display screen, a touch-sensitive display, and/or a projector) in communication with the computer system, the respective representation of the first asset. In some examples, rendering the respective representation of the first asset includes synthesizing an image and/or a video.

In some examples, a first performance measurement of the one or more current performance measurements is measured (e.g., computed, ascertained, received, assessed, determined, and/or identified) before receiving the request to render the first asset.

In some examples, a second performance measurement of the one or more current performance measurements is measured (e.g., computed, ascertained, received, assessed, determined, and/or identified) in response to receiving the request to render the first asset.

In some examples, a third performance measurement of the one or more current performance measurements is determined by rendering another asset different from the first asset. In some examples, the third performance measurement of the one or more current performance measurements is determined by computing an amount of resources (e.g., time, memory, network bandwidth, number of operations, and/or processor time) required for rendering the first asset (e.g., in the first manner and/or the second manner) using an amount of resources required to render the other asset. In some examples, the third performance measurement of the one or more current performance measurements is determined by comparing the amount of resources required for rendering the first asset and an amount (e.g., a target threshold) of resources available and/or used for a predefined amount of time (e.g., currently and/or predicted in the future). In some examples, the first asset is rendered in the first manner when the amount of resources required for rendering the first asset in the first manner is below the target threshold. In some examples, the first asset is rendered in the second manner when the amount of resources required for rendering the first asset in the second manner is below the target threshold.

In some examples, the computer system receives (e.g., before, concurrently, or after receiving the request to render the first asset and before, concurrently, or after rendering the 3D representation of the first asset) a request to render a second asset different from the first asset. In some examples, in response to receiving the request to render the second asset (e.g., and in accordance with a determination that the second set of one or more criteria is satisfied), the computer system renders a 2D representation of the second asset. In some examples, after receiving the request to render the first asset and after rendering the 2D representation of the first asset, the computer system receives a request to render a third asset different from the first asset. In some examples, in response to receiving the request to render the third asset (e.g., and in accordance with a determination that the first set of one or more criteria is satisfied), the computer system renders a 3D representation of the third asset.

In some examples, after receiving the request to render the first asset and after rendering the 3D representation of the first asset, the computer system receives a second request to render the first asset. In some examples, in response to receiving the second request to render the first asset (e.g., and in accordance with a determination that the second set of one or more criteria is satisfied), the computer system renders the 2D representation of the first asset. In some examples, after receiving the request to render the first asset and after rendering the 2D representation of the first asset, the computer system receives a third request to render the first asset. In some examples, in response to receiving the third request to render the first asset (e.g., and in accordance with a determination that the first set of one or more criteria is satisfied), the computer system renders the 3D representation of the first asset.

In some examples, receiving the request to render the first asset includes detecting, via one or more input devices (e.g., a camera (e.g., a telephoto camera, a wide-angle camera, and/or an ultra-wide-angle camera), a microphone, a sensor (such as a heart rate sensor), a touch-sensitive surface, a mouse, a keyboard, a touch pad, and/or an input mechanism (e.g., a physical input mechanism, such as a rotatable input mechanism and/or a button)) in communication with the computer system, an input (e.g., a tap input and/or a non-tap input, such as an air input (e.g., a pointing air gesture, a tapping air gesture, a swiping air gesture, and/or a moving air gesture), a gaze input, a gaze-and-hold input, a mouse click, a mouse click-and-drag, a key input of a keyboard, a voice command, a selection input, and/or an input that moves the computer system in a particular direction and/or to a particular location) directed to a file (e.g., a container storing data and/or information) (e.g., a representation of the file) corresponding to the first asset.

In some examples, receiving the request to render the first asset includes detecting, via an application of the computer system, a request from a first portion of the application to render a second portion of the application. In some examples, the first portion corresponds to a first user interface and/or a portion of the first user interface. In some examples, the second portion corresponds to the portion of the first user interface, another portion different from the portion of the first user interface, and/or a second user interface different from the first user interface. In some examples, the first portion corresponds to a first portion (e.g., a level, an area of a virtual world, and/or a set of one or more objects) of an experience (e.g., a game, a central experience, and/or meeting point (e.g., socializing point and/or origin), and/or a currently viewable portion) of the application. In some examples, the second portion corresponds to a second portion (e.g., a second level different from the level, a second area of the virtual world different from the area, and/or a second set of one or more objects different from the set of one or more objects) of the experience of the application. In some examples, the second portion is different from the first portion.

In some examples, while the 3D representation of the first asset is being displayed (e.g., after and/or as part of rendering the 3D representation of the first asset), the computer system detects a change to the one or more current performance measurements of the computer system. In some examples, in response to detecting the change to the one or more current performance measurements of the computer system, the computer system renders the 2D representation of the first asset. In some examples, while the 2D representation of the first asset is being displayed (e.g., after and/or as part of rendering the 2D representation of the first asset), the computer system detects a second change to the one or more current performance measurements of the computer system. In some examples, in response to detecting the second change to the one or more current performance measurements of the computer system, the computer system renders the 3D representation of the first asset.

Note that details of the processes described above with respect to method 600 (e.g., FIG. 6) are also applicable in an analogous manner to the methods described herein. For example, method 500 optionally includes one or more of the characteristics of the various methods described above with reference to method 600. For example, rendering the first asset in the first manner of method 500 can be rendering the 3D representation of the first asset of method 600. For another example, rendering the first asset in the second manner of method 500 can be rendering the 2D representation of the first asset of method 600. For brevity, these details are not repeated below.

In some examples, a peer to view called Model3D is provided. In some examples, Model3d asynchronously loads 3D scenes using the same loading rules as an Entity. In some examples, Model3D loads models from a network. In such examples, the models are loaded similarly to how an image would asynchronously load in a 2D framework.

In some examples, Model3D can be thought of as a 3D peer of images. For example, images have an intrinsic size, and by default they render at their intrinsic size, potentially overflowing the bounds of their containers. In some examples, an image has a resizable ( ) modifier, which switches the image into a mode where it scales itself in X and Y to fill its containing bounds. In some examples, Model3D will behave much the same. In some examples, Model3D content, by default, is not resizable. In such examples, Model3D content renders at their intrinsic size. In some examples, the intrinsic size is reported back up to a 2D framework layout system. In such examples, by being reported to the 2D framework layout system, Model3D content can be positioned within other layout containers and can participate (e.g., fully participate) in layout. In some examples, Model3D content will have a .resizable( ) modifier, which makes them scale to fill their parent container. In some examples, .resizeable( ) modifier can be combined with .scaledToFit( ) and .scaledToFill( ) modifiers to allow content to scale up and preserve its aspect ratio.

In some examples, processes can create Model3D content in three ways: by scene name in a given bundle, by loading a file on disk, and/or by downloading a file from a network URL. In some examples, when Model3D content finishes loading, the Model3D content computes a size of a scene that it is included in via visualBounds (relativeTo: nil), and uses that as an intrinsic size of a model for layout. In such examples, the Model3D content is able to be displayed inside of a view hierarchy without needing to provide any explicit frame. In some examples, if Model3D content is resizable, the Model3D content will scale itself to fill a container using that bounding size.

Consider a view that displays an assortment of computers on a shelf. In some examples, processes can use a Model3D content to asynchronously load all 3D models and use regular VStack's and Hstack's to position them relative to each other.

```
struct Shelf: View {
  var body: some View {
    HStack(alignment: .bottom) {
      VStack {
        Model3D(named: ″Computer″)
        Text(″Computer″)
      }
      ForEach([13, 14, 16], id: \.self) { displaySize in
        VStack {
          Model3D(named: ″Computer \(displaySize)″)
          Text(″Computer \(displaySize)-inch″)
        }
      }
    }
  }
}
‘‘‘
```

In some examples, Model3D content is loaded asynchronously, and is added to a hierarchy when the load is finished. In such examples, if processes wish to customize content of a model after it has loaded, the processes can provide a content closure to add modifiers to the ResolvedModel3D view in the hierarchy.

```
  Model3D(named: ″Computer″) { model in
    model
      // Specifies that the model should automatically scale itself to fill
      the container.
      .resizable( )
      // Specifies that the model should retain its intrinsic aspect ratio
      and scale such that
      // the largest of the 3 axes fits the smallest of the 3 container axes.
      .scaledToFit( )
  }
  “‘
```

If clients wish to customize the appearance of the placeholder, they can do that as well via a second placeholder parameter to the Model3D initializer.

```
  Model3D(url: usdzURL) { model in
    model
      .resizable( )
      .scaledToFit( )
  } placeholder: {
    ProgressView( )
      .controlSize(.large))
  }
  ‘‘‘
```

In some examples, if processes wish to display an error message if the model failed to load, an initializer can be provided that provides access to the loading phase as a structured enum instead.

```
struct RobotModel: View {
  static let robotModelURL = URL(string:
  ″https://example.com/robot.usdz″)!
  var body: some View {
    Model3D(url: robotModelURL) { phase in
      switch phase {
      case .empty:
        ProgressView( )
          .controlSize(.large)
      case .success(let model):
        model
          .resizable( )
          .scaledToFit( )
      case .failure(let error):
        Text(error.localizedDescription)
      }
    }
  }
}
‘‘‘
```

In some examples, the full phase-driven content closure optionally accepts a Transaction in which the loading phase changes will be executed. In such examples, processes are allowed to animate the phase transition however they need.

In some examples, because Model3D is a view, a 2D framework gesture system works on Model3D content. In such examples, the 2D framework's gesture system handles (e.g., transparently handles) entities embedded in applications. By doing such, gestures can work with models using an expanded set of 3D layout and effect APIs introduced in a mixed reality operating system. For example, processes can create a turntable-style UI by adding a DragGesture to a Model3D and applying rotation to the underlying ResolvedModel3D when it loads.

struct RotateGestureExample: View {
@GestureState var inflightYaw: Double = . zero
@State var yaw: Double = zero
var body: some View {
Model3D(named: ″Computer″) { model in
model
.resizable()
.aspectRatio(contentMode: . fit)
.rotation3DEffect(.degrees(-(yaw + inflightYaw)), axis: (0, 1, 0))
gesture(turntableGesture)
} placeholder: {
Progress View()
frame(maxHeight: . infinity)
var turntableGesture: some Gesture {
DragGesture()
.updating($inflightYaw) { value, state, transaction in
state = value.translation.width
}
.onEnded { value in
yaw += value.translation.width
let falloff = value.predictedEndTranslation.width -
value.translation. width
with Animation(.spring()) {
yaw += falloff
}
}
‘‘‘
/// A view for displaying static three-dimensional models.
///
/// You don't instantiate this type directly, instead ″Model3D″ creates
/// instances for you.
@available(phoneOS, unavailable)
@available(computerOS, unavailable)
@available(wearableOS, unavailable)
@available(mediaOS, unavailable)
@available(mixedrealityOS, *)
public struct ResolvedModel3D: View, Equatable {
/// Allows this model to resize itself to fit its container.
/// - Note: By default, 'Model3D' sizes itself based on the intrinsic size
/// of the underlying model file. Setting this will scale the model to
/// fit its container instead. To preserve the intrinsic aspect ratio of
/// the model, use ″ aspectRatio( _: contentMode:)″.
public func resizable(_isResizable: Bool = true) -> ResolvedModel3D
}
/// The current phase of the asynchronous model loading operation.
///
/// When you create a ″Model3D″ instance with the
///`Model3D/init(url:transaction:content:)″ initializer, you define
/// the appearance of the view using a 'content' closure. 2D framework calls the
/// closure with a phase value at different points during the load operation
/// to indicate the current state. Use the phase to decide what to display.
/// For example, you can display the loaded model if it exists, a view that
/// indicates an error, or a placeholder:
/// let url = URL(string: ″https://example.com/robot.usdz″)!
/// Model3D(url: url) { phase in
/// if let model = phase.model {
/// model // Displays the loaded model.
/// } else if phase.error != nil {
/// Color.red // Indicates an error.
/// } else {
/// Progress View()
@available(phoneOS, unavailable)
@available(computerOS, unavailable)
@available(wearableOS, unavailable)
@available(mediaOS, unavailable)
@available(mixedrealityOS 1.0, *)
public enum Model3DPhase {
/// No model is loaded.
case empty
/// A model has succesfully loaded.
case success(ResolvedModel3D)
/// An model failed to load with an error.
case failure(Error)
/// The loaded model, if any.
///
/// If this value isn't `nil', the model load operation has finished,
/// and you can use the model to update the view. You can use the model
/// directly, or you can modify it in some way. For example, you can add
/// a ″Model3D/resizable()″ modifier to make the
/// model resizable.
public var model: Model3D? { get }
/// The error that occurred when attempting to load a model, if any.
public var error: Error? { get }
}
/// A view that asynchronously loads and displays a 3D model.
///
/// Use `Model3D' if you want to embed a 3D model from a USD file or Reality
/// file in an application using a 2D framework.
/// You can use methods on the 'ResolvedModel3D' type as well as
/// standard view modifiers to adjust the size of the model to fit your app's
/// interface. Here, the ″ResolvedModel3D/resizable( :)″ method scales the
/// model to fit the current view.
/// Then, the ″View/aspectRatio( _: contentMode:)-77low″ view modifier adjusts
/// this resizing behavior to maintain the model's original aspect ratio, rather
/// than scaling the x-, y-, and z-axes independently to fit the robot to the
/// full frame of the view.
/// Model3D(named: ″Robot-Drummer″) { model in
/// model
/// .resizable()
/// .aspectRatio(contentMode: . fit)
/// } placeholder: {
/// Progress View()
// }
/// If loading from a remote URL, this view uses the shared
/// <doc://com.apple.documentation/documentation/Foundation/URLSession>
/// instance to load a model from the specified URL, and then display it.
/// For example, you can display a model that's stored on a server:
///
/// Model3D(url: URL(string: ″https://example.com/robot.usdz″)!)
/// .frame(width: 300, height: 600)
/// Until the model loads, the view displays a standard placeholder that
/// fills the available space. After the load completes successfully, the view
/// updates to display the model. In the example above, the model is smaller
/// than the frame, and so appears smaller than the placeholder.
///
/// ![A diagram that shows a grey box on the left, a robot drummer model on the
/// right, and an arrow pointing from the first to the second. The model
/// is about half the width of the grey box.](AsyncModel-1)
///
/// You can specify a custom placeholder using
/// ``init(url:content:placeholder:)″. With this initializer, you can
/// also use the 'content' parameter to manipulate the loaded model.
/// For example, you can add a modifier to make the loaded image resizable:
///
/// let url = URL(string: ″https://example.com/robot.usdz″)!
/// Model3D(url: url) { model in
/// model.resizable()
/// } placeholder: {
/// Progress View()
/// }
/// frame(width: 50, height: 50)
///
/// For this example, a 2D framework shows a ″ProgressView″ first, and then the
/// model scaled to fit in the specified frame:
///
/// ![A diagram that shows a progress view on the left, a robot drummer model
/// on the right, and an arrow pointing from the first to the
/// second.](AsyncModel-2)
/// > Important: You can't apply ″ResolvedModel3D″-specific modifiers, like
///>″ResolvedModel3D/resizable( _: )″, directly to a `Model3D″.
/// > Instead, apply them to the 'ResolvedModel3D' instance that your `content
/// > closure gets when defining the view's appearance.
///
/// To gain more control over the loading process, use the
/// `init(url:transaction:content:)″ initializer, which takes a
///`content' closure that receives a ″Model3DPhase″ to indicate
/// the state of the loading operation. Return a view that's appropriate
/// for the current phase:
/// let url = URL(string: ″https://example.com/robot.usdz″)!
/// Model3D(url: url) { phase in
/// if let model = phase.model {
/// model // Displays the loaded model.
/// } else if phase.error != nil {
/// Color.red // Indicates an error.
/// } else {
/// Color.blue // Acts as a placeholder.
///
@available(phoneOS, unavailable)
@available(computerOS, unavailable)
@available(wearableOS, unavailable)
@available(mediaOS, unavailable)
@available(mixedrealityOS 1.0, *)
public struct Model3D<Content: View> {
/// Loads and displays a model from the specified URL.
/// Until the model loads, a 2D framework displays a default placeholder. When
/// the load operation completes successfully, the 2D framework updates the
/// view to show the loaded model. If the operation fails, the 2D framework
/// continues to display the placeholder. The following example loads
/// and displays a model from an example server:
///
/// Model3D(url: URL(string: ″https://example.com/robot.usdz″
///
/// If you want to customize the placeholder or apply ″Model3D″-specific
/// modifiers --- like ″Model3D/resizable()″ ---
/// to the loaded model, use the ″init(url: content: placeholder:)″
/// initializer instead.
/// - Parameters:
/// - url: The URL of the model to display.
public init(url: URL) where Content == ResolvedModel3D
/// Loads and displays a modifiable model from the specified URL using
/// a custom placeholder until the model loads.
/// Until the model loads, 'Model3D' displays the placeholder view that
/// you specify. When the load operation completes successfully, 'Model3D'
/// updates the view to show content that you specify, which you
/// create using the loaded model. For example, you can show a green
/// placeholder, followed by a scaled version of the loaded model:
/// let url = URL(string: ″https://example.com/robot.usdz″)!
/// Model3D(url: url) { model in
/// model.resizable()
/// } placeholder: {
/// Color.green
///
/// If the load operation fails, 'Model3D' continues to display the
/// placeholder. To be able to display a different view on a load error,
/// use the ″init(url:transaction:content:)″ initializer instead.
/// - Parameters:
/// - url: The URL of the model to display.
/// - content: A closure that takes the loaded model as an input, and
/// returns the view to show. You can return the model directly, or
/// modify it as needed before returning it.
/// - placeholder: A closure that returns the view to show until the
/// load operation completes successfully.
public init<Model: View, Placeholder: View>(
url: URL,
@ViewBuilder content: @escaping (ResolvedModel3D) -> Model,
@ViewBuilder placeholder: @escaping () -> Placeholder
) where Content == Model3DPlaceholderContent<Model, Placeholder>
/// Loads and displays a modifiable model from the specified URL in phases.
/// If you set the asynchronous model's URL to 'nil', or after you set the
/// URL to a value but before the load operation completes, the phase is
/// ″Model3DPhase/empty″. After the operation completes, the phase
/// becomes either ″Model3DPhase/failure( :)″ or
/// `Model3DPhase/success( _: )″. In the first case, the phase's
///`Model3DPhase/error″ value indicates the reason for failure.
/// In the second case, the phase's ″Model3DPhase/model″ property
/// contains the loaded model. Use the phase to drive the output of the
///`content' closure, which defines the view's appearance:
/// let url = URL(string: ″https://example.com/robot.usdz″)!
/// Model3D(url: url) { phase in
/// if let model = phase.model {
/// model // Displays the loaded model.
/// } else if phase. error != nil {
/// Color.red // Indicates an error.
/// } else {
/// Color.blue // Acts as a placeholder.
///
/// To add transitions when you change the URL, apply an identifier to the
/// ``Model3D″.
/// - Parameters:
/// - url: The URL of the image to display.
/// - transaction: The transaction to use when the phase changes.
/// - content: A closure that takes the load phase as an input, and
/// returns the view to display for the specified phase.
public init(
url: URL,
transaction: Transaction = Transaction(),
@ViewBuilder content: @escaping (Model3DPhase) -> Content)
/// Loads and displays a model by name, by searching through the specified
/// ``Foundation/Bundle″.
///
/// Until the model loads, 'Model3D' displays a default placeholder. When
/// the load operation completes successfully, ″Model3D` updates the
/// view to show the loaded model. If the operation fails, 'Model3D'
/// continues to display the placeholder. The following example loads
/// and displays a model from an example server:
/// Model3D(named: ″Robot-Drummer″)
/// If you want to customize the placeholder or apply ″Model3D″-specific
/// modifiers --- like ″Model3D/resizable()″ ---
/// to the loaded model, use the ″init( _: bundle:content:placeholder:)″
/// initializer instead.
///
/// - Parameters:
/// - name: The name of the USD or Reality file to display.
/// - bundle: The Bundle used to look up the model by name. If not
/// provided, defaults to the app's main bundle.
public init(
named name: String,
bundle: Bundle = . main
) where Content == ResolvedModel3D
/// Loads and displays a modifiable model by name, by searching
/// through the specified ″Foundation/Bundle″, using a custom placeholder
/// until the model loads.
/// Until the model loads, 'Model3D' displays the placeholder view that
/// you specify. When the load operation completes successfully, `Model3D
/// updates the view to show content that you specify, which you
/// create using the loaded model. For example, you can show a green
/// placeholder, followed by a scaled version of the loaded model:
///
/// Model3D(named: ″Robot-Drummer″) { model in
/// model.resizable()
/// } placeholder: {
/// Color.green
///
/// If the load operation fails, 'Model3D' continues to display the
/// placeholder. To be able to display a different view on a load error,
/// use the ″init( _: bundle:transaction:content:)″ initializer instead.
///
/// - Parameters:
/// - name: The name of the USD or Reality file to display.
/// - bundle: The Bundle used to look up the model by name. If not
/// provided, defaults to the app's main bundle.
/// - content: A closure that takes the loaded model as an input, and
/// returns the view to show. You can return the model directly, or
/// modify it as needed before returning it.
/// - placeholder: A closure that returns the view to show until the
/// load operation completes successfully.
public init<Model: View, Placeholder: View>(
named name: String,
bundle: Bundle = . main,
@ViewBuilder content: @escaping (ResolvedModel3D) -> Model,
@ViewBuilder placeholder: @escaping () -> Placeholder
) where Content == Model3DPlaceholderContent<Model, Placeholder>
/// Loads and displays a modifiable model by name, by searching
/// through the specified ″Foundation/Bundle″, in phases.
///
/// Before the load operation completes, the phase is
///`Model3DPhase/empty″. After the operation completes, the phase
/// becomes either ″Model3DPhase/failure( _: )″ or
/// ``Model3DPhase/success( _: )″. In the first case, the phase's
/// ``Model3DPhase/error″ value indicates the reason for failure.
/// In the second case, the phase's ″Model3DPhase/model″ property
/// contains the loaded model. Use the phase to drive the output of the
///`content' closure, which defines the view's appearance:
///
/// Model3D(named: ″Robot-Drummer″) { phase in
/// if let model = phase.model {
/// model // Displays the loaded model.
/// } else if phase. error != nil {
/// Color.red // Indicates an error.
/// } else {
/// Color.blue // Acts as a placeholder.
/// }
/// }
/// To add transitions when you change the name, apply an identifier to the
/// ``Model3D″.
///
/// - Parameters:
/// - name: The name of the USD or Reality file to display.
/// - bundle: The Bundle used to look up the model by name. If not
/// provided, defaults to the app's main bundle.
/// - transaction: The transaction to use when the phase changes.
/// - content: A closure that takes the load phase as an input, and
/// returns the view to display for the specified phase.
public init(
named name: String,
bundle: Bundle = . main,
transaction: Transaction = Transaction(),
@ViewBuilder content: @escaping (Model3DPhase) -> Content)
/// A container view that presents either a ResolvedModel3D or a placeholder view.
/// This type is used internally by Model3D.
@available(phoneOS, unavailable)
@available(computerOS, unavailable)
@available(wearableOS, unavailable)
@available(mediaOS, unavailable)
@available(mixedrealityOS 1.0, *)
public struct Model3DPlaceholderContent<Model: View, Placholder: View>: View {
var body: some View { get }
}
‘‘‘

As described above, one aspect of the present technology is the gathering and use of data available from specific and legitimate sources for providing content. The present disclosure contemplates that in some instances, this gathered data may include personal information data that uniquely identifies or can be used to identify a specific person. Such personal information data can include audio data, voice data, demographic data, location-based data, online identifiers, telephone numbers, email addresses, home addresses, encryption information, data or records relating to a user's health or level of fitness (e.g., vital signs measurements, medication information, exercise information), date of birth, or any other personal information.

The present disclosure recognizes that the use of personal information data, in the present technology, can be used to the benefit of users. For example, the personal information data can be used for providing content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominently and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of techniques for rendering content, the present technology can be configured to allow users to select to “opt in” or “opt out” of participation in the collection and/or sharing of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level or at a scale that is insufficient for facial recognition), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

FIG. 7 illustrates an electronic system 700 with which some examples of the subject technology may be implemented. The electronic system 700 can be, and/or can be a part of, the electronic device 105, the handheld electronic device 104, the electronic device 110, the electronic device 115, and/or the server 120 as shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and chipset buses that communicatively connect the numerous internal devices of the electronic system 700. In some examples, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different examples.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In some examples, a mass-storage device (such as a magnetic or optical disk and its corresponding disk drive) may be used as the permanent storage device 702.

In some examples, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In some examples, the processes of the subject disclosure are stored in the system memory 704, the permanent storage device 702, and/or the ROM 710 (which are each implemented as a non-transitory computer-readable medium). From these various memory units, the one or more processing unit(s) 712 retrieves instructions to execute and data to process in order to execute the processes of some examples.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. Some examples may include devices that function as both input and output devices, such as a touchscreen. In these examples, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the electronic device 110 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

These functions described above can be implemented in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some examples include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some examples are performed by one or more integrated circuits, such as application specific integrated circuits (ASICs) or field programmable gate arrays (FPGAs). In some examples, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, some examples of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an example of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

Some examples within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some examples, the tangible computer-readable storage medium can be directly coupled to a computing device, while in other examples, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, some examples are performed by one or more integrated circuits, such as ASICs or FPGAs. In some examples, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In some examples, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In some examples, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more examples, some examples, other examples, such examples, one example, for example, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other examples. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
at a computer system:
receiving a request to render a first asset; and
in response to receiving the request to render the first asset:
in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and
in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

2. The method of claim 1, wherein rendering the first asset in the first manner includes providing a 3D representation of the first asset, and wherein rendering the first asset in the second manner includes providing a 2D representation of the first asset.

3. The method of claim 1, wherein rendering the first asset in the first manner includes providing an animation of the first asset or rendering a representation of the first asset with a physics setting applied to the representation, and wherein rendering the first asset in the second manner does not include rendering an animation of the first asset and does not include rendering a representation of the first asset with the physics setting applied to the representation.

4. The method of claim 1, wherein the first asset is displayed while audio is playing, the method further comprising:
in response to detecting a change to a current performance measurement, ceasing playback of the audio.

5. The method of claim 1, wherein rendering the first asset in the first manner includes providing a first portion of the first asset with a first texture, and wherein rendering the first asset in the second manner includes providing the first portion of the first asset with a second texture different from the first texture.

6. The method of claim 1, wherein rendering the first asset in the first manner includes providing the first asset in a first resolution, and wherein rendering the first asset in the second manner includes providing the first asset in a second resolution different from the first resolution.

7. The method of claim 1, wherein rendering the first asset includes displaying, via a first display generation component in communication with the computer system, the first asset.

8. The method of claim 1, wherein a first performance measurement of the first set of one or more current performance measurements is measured before receiving the request to render the first asset.

9. The method of claim 1, wherein a second performance measurement of the first set of one or more current performance measurements is measured in response to receiving the request to render the first asset.

10. The method of claim 1, wherein a third performance measurement of the first set of one or more current performance measurements is determined by rendering another asset different from the first asset.

11. The method of claim 1, further comprising:
receiving a request to render a second asset different from the first asset; and
in response to receiving the request to render the second asset, rendering the second asset in the second manner.

12. The method of claim 1, further comprising:
after receiving the request to render the first asset and after rendering the first asset in the first manner, receiving a second request to render the first asset; and
in response to receiving the second request to render the first asset, rendering the first asset in the second manner.

13. The method of claim 1, wherein receiving the request to render the first asset includes detecting, via one or more input devices in communication with the computer system, an input directed to a file corresponding to the first asset.

14. The method of claim 1, wherein receiving the request to render the first asset includes detecting, via an application of the computer system, a request from a first portion of the application to render a second portion of the application.

15. The method of claim 1, further comprising:
while the first asset is being displayed, detecting a change to one or more current performance measurements of the computer system; and
in response to detecting the change to the one or more current performance measurements, rendering the first asset in a different manner than the first asset that was displayed when detecting the change.

16. The method of claim 1, further comprising:
in response to receiving the request to render the first asset:
in accordance with a determination that a third set of one or more criteria is satisfied, wherein the third set of one or more criteria includes a criterion that is satisfied when the request to render the first asset does not include a size to render the first asset, rendering the first asset at a first size; and
in accordance with a determination that a fourth set of one or more criteria is satisfied, wherein the fourth set of one or more criteria includes a criterion that is satisfied when the request to render the first asset includes a second size to render the first asset, rendering the first asset at the second size, wherein the fourth set of one or more criteria is different from the third set of one or more criteria, and wherein the second size is different from the first size.

17. A non-transitory computer-readable storage medium storing one or more programs configured to be executed by one or more processors of a computer system, the one or more programs including instructions for:
receiving a request to render a first asset; and
in response to receiving the request to render the first asset:
in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof; and
in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.

18. A computer system, comprising:
one or more processors; and
memory storing one or more programs configured to be executed by the one or more processors, the one or more programs including instructions for:
receiving a request to render a first asset; and
in response to receiving the request to render the first asset:
in accordance with a determination that a first set of one or more criteria is satisfied, wherein the first set of one or more criteria includes a criterion based on a first set of one or more characteristics of the first asset and a first set of one or more current performance measurements of the computer system, rendering the first asset in a first manner, wherein the first set of one or more characteristics includes a number of vertices desired to be rendered for the first asset, a texture size of a portion of a representation of the first asset, a physics setting applied to a representation of the first asset, an animation defined by the first asset, or a combination thereof, and
in accordance with a determination that a second set of one or more criteria is satisfied, wherein the second set of one or more criteria includes a criterion based on a second set of one or more characteristics of the first asset and a second set of one or more current performance measurements of the computer system, rendering the first asset in a second manner different from the first manner, wherein the second set of one or more criteria is different from the first set of one or more criteria.
